(19) United States
(12) Patent Application Publication
(10) Pub. No.: US 2021/0263459 A1
(43) Pub. Date: Aug. 26, 2021

(54) IMAGE FORMING APPARATUS

(71) Applicant: CANON KABUSHIKI KAISHA, Tokyo (JP)

(72) Inventor: Tomoya Inuzuka, Chiba (JP)

(21) Appl. No.: 17/177,339

(22) Filed: Feb. 17, 2021

(30) Foreign Application Priority Data
Feb. 26, 2020 (JP) 2020-031083

(51) Int. Cl. G03G 15/00; G03G 15/16

(52) U.S. Cl. CPC G03G 15/5008; G03G 15/1675

(57) ABSTRACT

An image forming apparatus includes an image forming portion, a rotatable intermediary transfer belt, a plurality of stretching rollers, an outer roller, a moving mechanism capable of moving a position of the inner roller between a first position and a second position, a recording material feeding member, a driving source, and a controller. The controller controls the driving source so that when an image is formed in a state in which the inner roller is in a first position, a speed ratio Vp/Vb wherein Vp is a driving speed of the feeding member and Vb is a driving speed of the intermediary transfer belt is a first speed ratio, and when the image is formed in a state in which the inner roller is in a second position, the speed ratio Vp/Vb is a second speed ratio smaller than the first speed ratio.

### FIELD OF THE INVENTION AND RELATED ART

The present invention relates to an image forming apparatus, such as a copying machine, a printer or a facsimile machine, using an electrophotographic type or an electrostatic recording type.

Conventionally, as the image forming apparatus using the electrophotographic type, there is an image forming apparatus using an endless belt as an image bearing member for bearing a toner image. As such a belt, for example, there is an intermediary transfer belt used as a second image bearing member for feeding a sheet-like recording material such as paper from a photosensitive member or the like as a first image bearing member. In the following principally, an image forming apparatus employing an intermediary transfer type including an intermediary transfer belt will be described as an example.

In the image forming apparatus of the intermediary transfer type, a toner image formed on the photosensitive member or the like is primary-transferred onto the intermediary transfer belt at a primary transfer portion. Then, the toner image primary-transferred on the intermediary transfer belt is secondary-transferred onto the recording material at a secondary transfer portion. By an inner member (inner secondary transfer member) provided on an inner peripheral surface side and an outer member (outer secondary transfer member) provided on an outer peripheral surface side, a secondary transfer nip as the secondary transfer portion which is a contact portion between the intermediary transfer belt and the outer member is formed. As the inner member, an inner roller which is one of a plurality of stretching rollers for stretching the intermediary transfer belt is used. As the outer member, an outer roller which is provided in a position opposing the inner roller while nipping the intermediary transfer belt between itself and the inner roller and which is pressed toward the inner roller is used in many instances. Further, for example, a secondary transfer voltage of a polarity opposite to a charge polarity of toner is applied to the outer roller, so that the toner image is secondary-transferred from the intermediary transfer belt onto the recording material in the secondary transfer nip. In general, with respect to a feeding direction of the recording material, on a side upstream of the secondary transfer nip, a feeding guide for guiding the recording material to the secondary transfer nip is provided.

Here, depending on a shape of the secondary transfer nip, behavior of the recording material changes in the neighborhoods of the secondary transfer nip on sides upstream and downstream of the secondary transfer nip with respect to the recording material feeding direction. Further, in recent years, for example, it has been required to meet diversified recording materials in commercial printing market, but depending on rigidity of the recording material, the behavior of the recording material also changes in the neighborhoods of the secondary transfer nip on the sides upstream and downstream of the secondary transfer nip with respect to the recording material feeding direction. For example, in the case where the recording material is “thin paper” which is an example of the recording material with small rigidity, in the neighborhood of the secondary transfer nip on the side downstream of the secondary transfer nip with respect to the recording material feeding direction, the intermediary transfer belt and the recording material stick to each other, so that a jam (paper jam) occurs in some instances due to improper separation of the recording material from the intermediary transfer belt.

On the other hand, in the case where the recording material is “thick paper” which is an example of the recording material with large rigidity, when a trailing end of the recording material with respect to the recording material feeding direction passes through the feeding guide, a tailing end portion of the recording material with respect to the recording material feeding direction collides with the intermediary transfer belt in some instances. Then, with respect to the recording material feeding direction, an attitude of the intermediary transfer belt in the neighborhood of the secondary transfer nip on the upstream side is disturbed, so that an image defect (a stripe-shaped image disturbance or the like extending in a direction substantially perpendicular to the recording material feeding direction) occurs in some instances.

In order to solve such problems, a constitution in which a shape (position) of the secondary transfer nip is changed depending on a kind of the recording material has been proposed (Japanese Laid-Open Patent Application 2014-134718).

As described above, in order to realize improvement in separating property of the recording material from the intermediary transfer belt and suppression of the image defect at the trailing end portion of the recording material, it is effective that the shape (position) of the secondary transfer nip is changed depending on the kind of the recording material. This change in shape (position) of the secondary transfer nip can be made by changing a relative position (represented by an “offset amount” described later) between the inner roller and the outer roller with respect to a circumferential direction of the inner roller through movement of the inner roller or the outer roller.

In the above, conventional problems were described taking, as an example, the secondary transfer portion which is a transfer portion of the toner image from the intermediary transfer belt onto the recording material, but there are similar problems also as to another transfer portion of the toner image from another belt-shaped image bearing member such as a photosensitive belt onto the recording material.

### SUMMARY OF THE INVENTION

A principal object of the present invention is to provide an image forming apparatus capable of suppressing an occurrence of an image defect in a transfer portion due to a change in offset amount.

The object has been accomplished by the image forming apparatus according to the present invention.

According to an aspect of the present invention, there is provided an image forming apparatus comprising: an image forming portion configured to form a toner image; a rotatable intermediary transfer belt onto which the toner image formed by the image forming portion is transferred; a plurality of stretching rollers stretching the intermediary transfer belt and including an inner roller and an upstream roller provided adjacent to the inner roller on a side upstream of the inner roller with respect to a rotational direction of the intermediary transfer belt; an outer roller contacting an outer peripheral surface of the intermediary transfer belt and configured to form a transfer nip, where the toner image is transferred from the intermediary transfer belt onto a recording material, by nipping the intermediary transfer belt between itself and the inner roller; a moving mechanism capable of moving a position of the inner roller between a first position where an offset amount X is a first offset amount X1 and a second position where the offset amount X is a second offset amount X2 which is larger than the first offset amount X1 and which is larger than zero, wherein in a cross section perpendicular to a rotational axis direction of the inner roller, an external common tangential line between the inner roller and the upstream roller on a side where the intermediary transfer belt is stretched by these rollers is a reference line L1, a rectilinear line passing through a rotation center of the inner roller and perpendicular to the reference line L1 is an inner roller center line L2, a rectilinear line passing through a rotation center of the outer roller and perpendicular to the reference line L1 is an outer roller center line L3, and a distance between the inner roller center line L2 and the outer roller center line L3 is the offset amount X which is a positive value when the outer roller center line L3 is positioned upstream of the inner roller central line L2 with respect to the rotational direction of the intermediary transfer belt; a feeding member configured to feed the recording material to the transfer nip; a driving source configured to drive the feeding member; and a controller configured to control the driving source, wherein the controller controls the driving source so that when an image is formed in a state in which the inner roller is in the first position, a speed ratio Vp/Vb wherein Vp is a driving speed of the feeding member and Vb is a driving speed of the intermediary transfer belt is a first speed ratio, and when the image is formed in a state in which the inner roller is in the second position, the speed ratio Vp/Vb is a second speed ratio smaller than the first speed ratio.

According to another aspect of the present invention, there is provided an image forming apparatus comprising: an image forming portion configured to form a toner image; a rotatable intermediary transfer belt onto which the toner image formed by the image forming portion is transferred; a plurality of stretching rollers stretching the intermediary transfer belt and including an inner roller and an upstream roller provided adjacent to the inner roller on a side upstream of the inner roller with respect to a rotational direction of the intermediary transfer belt; an outer roller contacting an outer peripheral surface of the intermediary transfer belt and configured to form a transfer nip, where the toner image is transferred from the intermediary transfer belt onto a recording material, by nipping the intermediary transfer belt between itself and the inner roller; a driving source configured to drive the outer roller; a moving mechanism capable of moving a position of the inner roller between a first position where an offset amount X is a first offset amount X1 and a second position where the offset amount X is a second offset amount X2 which is larger than the first offset amount X1 and which is larger than zero, wherein in a cross section perpendicular to a rotational axis direction of the inner roller, an external common tangential line between the inner roller and the upstream roller on a side where the intermediary transfer belt is stretched by these rollers is a reference line L1, a rectilinear line passing through a rotation center of the inner roller and perpendicular to the reference line L1 is an inner roller center line L2, a rectilinear line passing through a rotation center of the outer roller and perpendicular to the reference line L1 is an outer roller center line L3, and a distance between the inner roller center line L2 and the outer roller center line L3 is the offset amount X which is a positive value when the outer roller center line L3 is positioned upstream of the inner roller central line L2 with respect to the rotational direction of the intermediary transfer belt; and a controller configured to control the driving source, wherein the controller controls the driving source so that when an image is formed in a state in which the inner roller is in the first position, a speed ratio Vp/Vb wherein Vp is a driving speed of the outer roller and Vb is a driving speed of the intermediary transfer belt is a first speed ratio, and when the image is formed in a state in which the inner roller is in the second position, the speed ratio Vp/Vb is a second speed ratio smaller than the first speed ratio.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic sectional view of a neighborhood of a secondary transfer nip, for illustrating an offset amount.

Parts (a) and (b) of FIG. 3 are schematic side views each showing an offset mechanism.

FIG. 4 is a schematic side view showing a part of the offset mechanism.

FIG. 5 is a schematic sectional view of a secondary transfer nip for illustrating a surface speed ratio.

FIG. 6 is a graph showing surface speeds of an intermediary transfer belt and a recording material at a periphery of the secondary transfer nip for each of offset amounts.

Parts (a) and (b) of FIG. 7 are schematic sectional views each for illustrating curvature of the secondary transfer nip.

FIG. 8 is a schematic block diagram showing a control mode of a principal part of an image forming apparatus of an embodiment 1.

FIG. 9 is a flowchart of control in the embodiment 1.

FIG. 10 is a flowchart of control in an embodiment 2.

FIG. 11 is a schematic block diagram showing a control mode of a principal part of an image forming apparatus according to an embodiment 3.

FIG. 12 is a flowchart of control in the embodiment 3.

### DESCRIPTION OF THE EMBODIMENTS

### Embodiment 1

### 1. General Constitution and Operation of Image Forming Apparatus

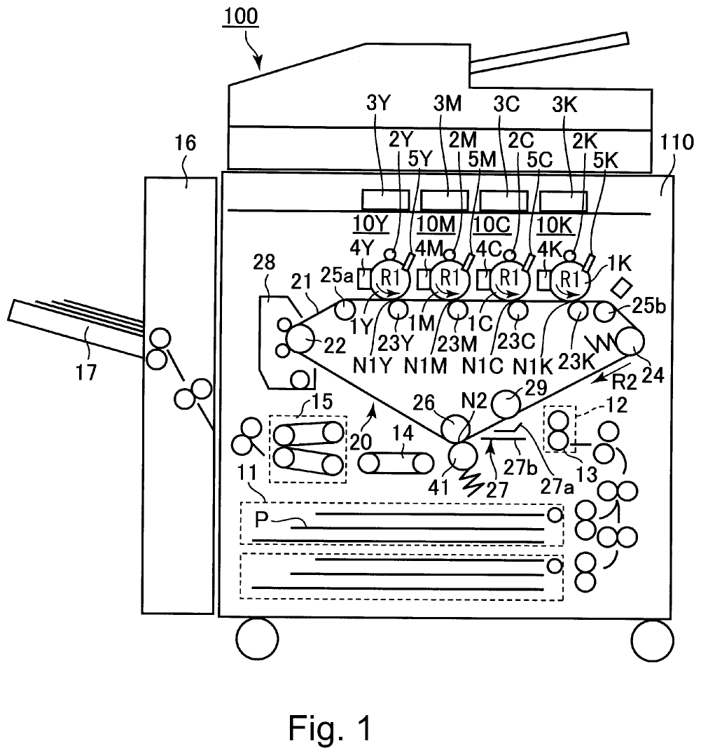

FIG. 1 is a schematic sectional view of an image forming apparatus 100 of the present invention. The image forming apparatus 100 in this embodiment is a tandem multi-function machine (having functions of a copying machine, a printer and a facsimile machines) employing an intermediary transfer type. For example, in accordance with an image signal sent from an external device, the image forming apparatus 100 is capable of forming a full-color image on a sheet-like recording material (a transfer material, a sheet material, a recording medium, media) P such as paper by using an electrophotographic type.

The image forming apparatus 100 includes, as a plurality of image forming portions (stations), four image forming portions 10Y, 10M, 10C and 10K for forming images of yellow (Y), magenta (M), cyan (C) and black (K). These image forming portions 10Y, 10M, 10C and 10K are disposed in line along a movement direction of an image transfer surface disposed substantially parallel to an intermediary transfer belt 21. As regards elements of the image forming portions 10Y, 10M, 10C and 10K having the same or corresponding functions or constitutions, suffixes Y, M, C and K for representing the elements for associated colors are omitted, and the elements will be collectively described in some instances. In this embodiment, the image forming portion 10 is constituted by including a photosensitive drum 1 (1Y, 1K, 1C, 1K), a charging device 2 (2Y, 2M, 2C, 2K), an exposure device 3 (3Y, 3M, 3C, 3K), a developing device 4 (4Y, 4M, 4C, 4K), a primary transfer roller 23 (23Y, 23M, 23C, 23K), a cleaning device 5 (5Y, 5M, 5C, 5K) and the like, which are described later.

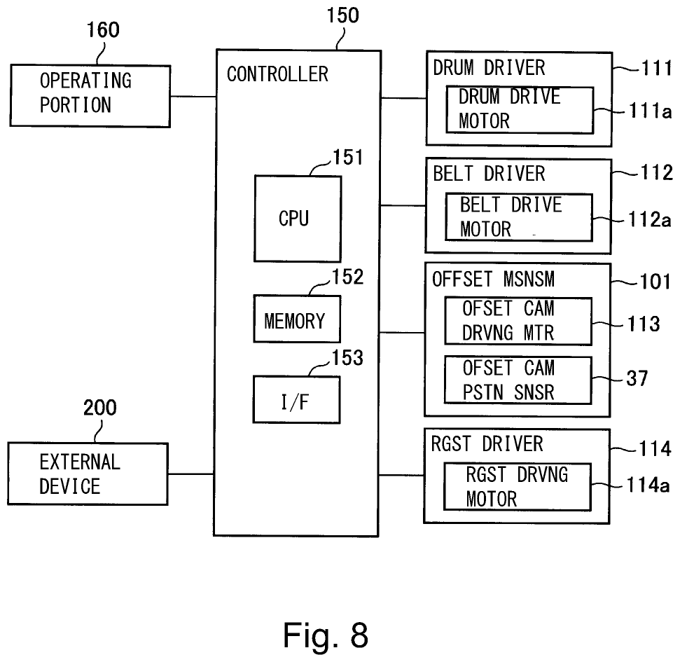

The image forming portion 10 is provided with the photosensitive drum 1 which is a rotatable drum-shaped (cylindrical) photosensitive member (electrophotographic photosensitive member) as a first image bearing member for bearing a toner image. To the photosensitive drum 1, a driving force is transmitted from a drum driving portion 111 (FIG. 8) as a driving means including a driving motor 111a as a driving source, so that the photosensitive drum 1 is rotationally driven in an arrow R1 direction (counterclockwise direction).

A surface of the rotating photosensitive drum 1 is electrically charged uniformly to a predetermined polarity (negative in this embodiment) and a predetermined potential by the charging device (charging roller) 2 as a charging means. During a charging process, to the charging device 2, a predetermined charging voltage is applied from a charging voltage source (not shown). The charged surface of the photosensitive drum 1 is subjected to scanning exposure to light depending on an image signal by the exposure device 3 as an exposure means (electrostatic image forming means), so that an electrostatic image (electrostatic latent image) is formed on the photosensitive drum 1. In this embodiment, the exposure device 3 is constituted by a laser scanner device for irradiating the surface of the photosensitive drum 1 with laser light modulated depending on an image signal. The electrostatic image formed on the photosensitive drum 1 is developed (visualized) by supplying toner as a developer by the developing device 4 as a developing means, so that a toner image (developer image) is formed on the photosensitive drum 1. In this embodiment, the toner charged to the same polarity (negative polarity in this embodiment) as a charge polarity of the photosensitive drum 1 is deposited on an exposed portion (image portion) of the photosensitive drum 1 where an absolute value of the potential is lowered by exposing to light the surface of the photosensitive drum 1 after the photosensitive drum 1 is uniformly charged (reverse development). The developing device 4 includes a developing roller, which is a rotatable developer carrying member, for feeding the developer to a developing position which is an opposing portion to the photosensitive drum 1 while carrying the developer. The developing roller is rotationally driven by transmitting thereto a driving force from a driving system for the photosensitive drum 1, for example. Further, during development, to the developing roller, a predetermined developing voltage is applied from a developing voltage source (not shown).

As a second image bearing member for bearing the toner image, the intermediary transfer belt 21 which is a rotatable intermediary transfer member constituted by an endless belt is provided so as to oppose the four photosensitive drums 1Y, 1M, 1C and 1K. The intermediary transfer belt 21 is extended around and stretched by a plurality of stretching (supporting) rollers including a driving roller 22, an upstream auxiliary roller 25a, a downstream auxiliary roller 25b, a tension roller 24, a pre-secondary transfer roller 29 and an inner roller 25. The driving roller 22 transmits a driving force to the intermediary transfer belt 21.

The tension roller 24 imparts predetermined tension to the intermediary transfer belt 21. The pre-secondary transfer roller 29 forms a surface of the intermediary transfer belt 21 in the neighborhood of a secondary transfer nip N2 (described later) on a side unit of the secondary transfer nip N2 with respect to a rotational direction (feeding direction, movement direction, traveling direction) of the intermediary transfer belt 21. The inner roller (secondary transfer opposite roller, inner member) 26 functions as an opposing member (opposite electrode) of an outer roller 41 (described later). The upstream auxiliary roller 25a and the downstream auxiliary roller 25b form the image transfer surface disposed substantially horizontally. The driving roller 22 is rotationally driven by transmission of the driving force thereto from a belt driving portion 112 (FIG. 8) as a driving means including a belt driving motor 112a as a driving source. By this, the driving force is inputted from the driving roller 22 to the intermediary transfer belt 21, so that the intermediary transfer belt 21 is rotated (circulated and moved) in an arrow R2 direction in FIG. 1. Of the plurality of stretching rollers, the stretching rollers other than the driving roller 22 are rotated by rotation of the intermediary transfer belt 21.

On the inner peripheral surface side of the intermediary transfer belt 21, the primary transfer rollers 23Y, 23M, 23C and 23K which are roller-like primary transfer members as primary transfer means are disposed correspondingly to the respective photosensitive drums 1Y, 1M, 1C and 1K. The primary transfer roller 23 is urged toward an associated photosensitive drum 1 through the intermediary transfer belt 21, whereby a primary transfer nip N1 which is a contact portion between the photosensitive drum 1 and the intermediary transfer belt 21 is formed.

The toner image formed on the photosensitive drum 1 as described above is primary-transferred onto the rotating intermediary transfer belt 21 at the primary nip N1 by the action of the primary transfer roller 23. During the primary transfer, to the primary transfer roller 23, a primary transfer voltage which is a DC voltage of an opposite polarity to a normal charge polarity (the charge polarity of the toner during the development) of the toner is applied by an unshown primary transfer voltage source. For example, during full-color image formation, the color toner images of yellow, magenta, cyan and black formed on the respective photosensitive drums 1 are successively primary-transferred superposedly onto the same image forming region of the intermediary transfer belt 21. In this embodiment, the primary transfer nip N1 is an image forming position where the toner image is formed on the intermediary transfer belt 21. The intermediary transfer belt 21 is an example of an endless belt rotatable while feeding the toner image carried in the image forming position.

On an outer peripheral surface side of the intermediary transfer belt 21, at a position opposing the inner roller 26, an outer roller (secondary transfer roller, outer member) 41 which is a roller-like secondary transfer member (rotatable transfer member) as a secondary transfer means is provided. The outer roller 41 is urged toward the inner roller 26 through the intermediary transfer belt 21 and forms the secondary transfer nip N2 as a secondary transfer portion which is a contact portion between the intermediary transfer belt 21 and the outer roller 41. The toner images formed on the intermediary transfer belt 21 as described above are secondary-transferred onto a recording material P sandwiched and fed by the intermediary transfer belt 21 and the outer roller 41 at the secondary transfer portion N2 by the action of the outer roller 41. In this embodiment, during the secondary transfer, to the outer roller 41, a secondary transfer voltage which is a DC voltage of the opposite polarity to the normal charge polarity of the toner is applied by a secondary transfer voltage source (not shown). In this embodiment, the inner roller 26 is electrically grounded (connected to the ground). Incidentally, the inner roller 26 is used as a secondary transfer member and a secondary transfer voltage of the same polarity as the normal charge polarity of the toner is applied thereto, and the outer roller 41 is used as an opposite electrode and may also be electrically grounded.

The recording material P is fed to the secondary transfer nip N2 by being timed to the toner image on the intermediary transfer belt 21. That is, the recording material P is accommodated in a recording material accommodating portion (cassette) 11. This recording material P is sent by a feeding portion (such as a feeding roller) provided in the recording material accommodating portion 11. The recording material P is fed to the secondary transfer nip N2 at predetermined timing after being adjusted in attitude by a registration adjusting portion 12. Here, the registration adjusting portion 12 includes a pair of registration rollers (registration roller pair) 13 which is a roller-shaped feeding member as a feeding means and a registration roller driving portion (feeding driving portion) 114 (FIG. 8) as a driving means for driving the registration rollers 13. The registration rollers 13 are rotationally driven by the registration roller driving portion 114, so that the recording material P is fed in a contact portion (nip) of the pair of registration rollers 13. Incidentally, the registration roller driving portion 114 includes a registration roller driving motor 114a (FIG. 8), and the registration roller driving portion 114 drives at least one (or may also be both) of the pair of registration rollers 13. In this embodiment, the number of rotations (turns) of the registration roller driving motor 114a of the registration roller driving portion 114 is controlled by a controller 150 (FIG. 8), so that the number of rotations of the registration rollers 130 is controlled and thus a feeding speed of the recording material P in the secondary transfer nip N2 is changeable. The recording material P fed from the recording material accommodating portion 11 is once stopped by the registration rollers 13. Then, this recording material P is sent into the secondary transfer nip N2 by rotational drive of the registration rollers 13 so that the toner image on the intermediary transfer belt 21 coincides with a desired image forming region on the recording material P in the secondary transfer nip N2.

With respect to the feeding direction of the recording material P, a feeding guide 27 for guiding the recording material P to the secondary transfer nip N2 is provided downstream of the registration rollers pairs 13 and upstream of the secondary transfer nip N2. The feeding guide 27 is constituted by including a first guiding member 27a contactable to a front surface of the recording material P (i.e., a surface onto which the toner image is to be transferred immediately after the recording material P passes through the feeding guide 27 and a second guiding member 27b contactable to a back surface of the recording material P (i.e., a surface opposite from the front surface). The image guiding member 27a and the second guiding member 27b are disposed opposed to each other, and the recording material P passes through between these members. The first guiding member 27a restricts movement of the recording material P in a direction toward the intermediary transfer belt 21. The second guiding member 82 27 restricts movement of the recording material P in a direction away from the intermediary transfer belt 21.

The recording material P on which the toner images are transferred is fed by a feeding belt 14 toward a fixing device 15 as a fixing means. The feeding belt 14 is driven by a feeding (belt) driving motor (not shown). On the inner peripheral surface side of the feeding belt 14, a suction fan (not shown) for attracting the recording material P is provided and attracts the recording material P toward the feeding belt 14. The fixing device 15 heats and presses the recording material P carrying thereon unfixed toner images, and thus fixes (melts) the toner images on the surface of the recording material P. Thereafter, the recording material P on which the toner images are fixed is discharged (outputted) to a discharge tray 17 provided on an outside of an apparatus main assembly 110 of the image forming apparatus 100 by a discharging device 16.

On the other hand, toner (primary transfer residual toner) remaining on the photosensitive drum 1 after the primary transfer is removed and collected from the surface of the photosensitive drum 1 by a cleaning device 5 as a cleaning means. Further, deposited matters such as toner (secondary transfer residual toner) remaining on the intermediary transfer belt 21 after the secondary transfer, and paper powder guided from the recording material P are removed and collected from the surface of the intermediary transfer belt 21 by a belt cleaning device 28 as an intermediary member cleaning means.

Incidentally, in this embodiment, an intermediary transfer belt unit 20 as a belt feeding device is constituted by including the intermediary transfer belt 21 stretched by the plurality of stretching rollers, the respective primary transfer rollers 23, the belt cleaning device 28, a frame supporting these members, and the like. The intermediary transfer belt unit 20 is mountable to and dismountable from the apparatus main assembly 110 for maintenance and exchange.

Here, as the intermediary transfer belt 21, a belt constituted by a resin-based material formed in a single layer structure or a multi-layer structure including an elastic layer constituted by an elastic material can be used. Further, as the intermediary transfer belt 21, a belt of 40 μm or more in thickness, 1.0 GPa or more in Young's modulus, 1.0×10⁹-5.0×10¹³ Ω/sq. in surface resistivity may preferably be used.

Further, in this embodiment, the inner roller 26 is constituted by providing an elastic layer (rubber layer) formed with a rubber material as an elastic material on an outer peripheral surface of a core metal (base material) made of metal. This elastic layer can be formed with an EPDM rubber (which may contain an electroconductive material), for example. In this embodiment, the inner roller 26 is formed so that an outer diameter thereof is 20 mm and a thickness of the elastic layer is 0.5 mm. Further, a hardness of the elastic layer of the inner roller 26 is set at, for example, about 70° (JIS-A). Incidentally, the inner roller 26 may also be constituted by a metal roller formed of a metal material such as SUM or SUS. The pre-secondary transfer roller 29 can be constituted, for example, similarly as in the case of the inner roller 26.

Further, in this embodiment, the outer roller 41 is constituted by providing an electroconductive elastic layer (which may also be a solid rubber layer or a sponge layer (elastic foam layer)) formed of an electroconductive rubber, material as an electroconductive elastic material on an outer peripheral surface of a core metal (base material). This elastic layer can be formed with, for example, metal complex, NBR rubber containing an electroconductive agent such as carbon black or EPDM rubber. In this embodiment, the outer roller 41 is formed so that an outer diameter of the core metal is 12 mm and a thickness of the elastic layer is 6 mm and so that an outer diameter thereof is 24 mm. Further, in this embodiment, a hardness of the elastic layer of the outer roller 41 is set at, for example, about 28° (Asker-C). Further, the outer roller 41 is rotatably supported by bearings 43 (FIG. 3) at opposite end portions thereof with respect to a rotational axis direction. The bearings 43 are slidable (movable) in a direction toward and away from the inner roller 26 and are pressed toward the inner roller 26 by urging spring 44 (FIG. 3) constituted by compression springs which are urging members (elastic members) as urging means. By this, the outer roller 41 contacts the intermediary transfer belt 21 toward the inner roller 26 at predetermined pressure and forms the secondary transfer nip N2. Further, in this embodiment, the outer roller 41 is rotated by the rotation of the intermediary transfer belt 21.

In this embodiment, rotational axis directions of the stretching rollers including the inner roller 26 for the intermediary transfer belt 21 and the outer roller 41 are substantially parallel to each other.

### 2. Offset

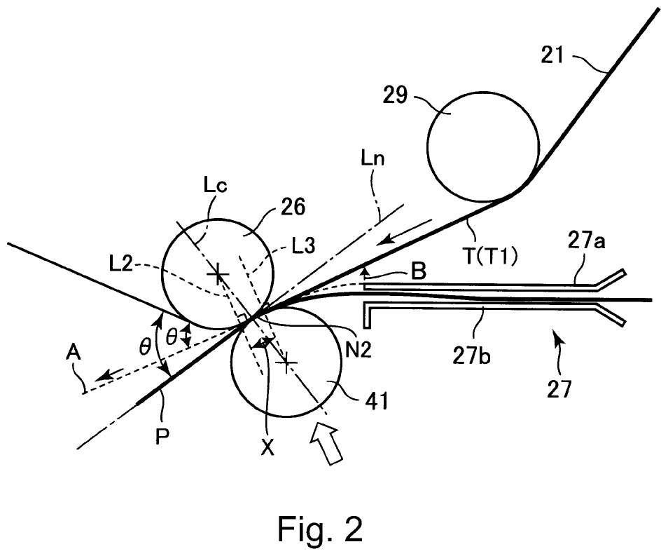

FIG. 2 is a schematic sectional view (of a cross section substantially perpendicular to the rotational axis direction of the inner roller 26) for illustrating behavior of the recording material P in the neighborhood of the secondary transfer nip N2. Incidentally, in FIG. 2, elements having identical and corresponding functions and constitutions to those of the image forming apparatus 100 of this embodiment are represented by the same reference numerals or symbols.

As described above, depending on the rigidity of the shape (position) of the secondary transfer nip n2 and the rigidity of the recording material P, the behavior of the recording material P in the neighborhood of the secondary transfer nip N2 on sides upstream and downstream of the secondary transfer nip N2 with respect to the feeding direction of the recording material P changes. Further, for example, in the case where the recording material P is “thin paper” which is an example of paper small in rigidity, a jam (paper jam) occurs in some instances due to improper separation of the recording material P from the intermediary transfer belt 21. This phenomenon becomes conspicuous in the case where the rigidity of the recording material P is small since the recording material P is liable to stick to the intermediary transfer belt 21 due to weak resilience of the recording material P.

That is, in the cross section shown in FIG. 2, a line showing a stretching surface of the intermediary transfer belt 21 stretched and formed by the inner roller 26 and the pre-secondary transfer roller 29 is a pre-nip stretching line T. The pre-secondary transfer roller 29 in an example of the upstream rollers, of the plurality of stretching rollers, disposed adjacent to the inner roller 26 on a side upstream of the inner roller 26 with respect to the rotational direction of the intermediary transfer belt 21. Further, in the same cross section, a rectilinear line passing through a rotation center of the inner roller 26 and a rotation center of the outer roller 41 is a nip center line Lc. In the same cross section, a rectilinear line substantially perpendicular to the nip center line Le is a nip line Ln. Incidentally, FIG. 2 shows a state in which with respect to a direction along the pre-nip stretching line T, the rotation center of the outer roller 41 is offset and disposed on a side upstream of the rotation center of the inner roller 26 with respect to the rotational direction of the intermediary transfer belt 21.

At this time, there is a tendency that the recording material P is liable to maintain an attitude substantially along the nip line Ln in a state in which the recording material P is nipped between the inner roller 26 and the outer roller 41. For that reason, in general, in the case where the rotation center of the inner roller 26 and the rotation center of the outer roller 41 are close to each other with respect to the direction along the pre-nip stretching line T, as shown by a broken line A in FIG. 2, a discharge angle θ of the recording material P becomes small. That is, a leading end of the recording material P adopts an attitude such that the recording material P is discharged near to the intermediary transfer belt 21 when the recording material P is discharged near to the intermediary transfer belt 21 when the recording material P is discharged from the secondary transfer nip N2. By this, the recording material P is liable to stick to the intermediary transfer belt 21. On the other hand, in general, in the case where the rotation center of the outer roller 41 is disposed on a side more upstream of the rotation center of the inner roller 26 with respect to the pre-nip rotation centering line T, as shown by a solid line in FIG. 2, the discharge angle θ of the recording material P becomes large. That is, the leading end of the recording material P adopt an attitude such that the recording material P is discharged in a direction away from the intermediary transfer belt 21 when the recording material P is discharged from the secondary transfer nip N2. By this, the recording material P does not readily stick to the intermediary transfer belt 21.

On the other hand, for example, in the case where the recording material P is “thick paper” which is an example of a recording material P large in rigidity, when a trailing end of the recording material P with respect to the feeding direction of the recording material P passes through the feeding guide 27, a trailing end portion of the recording material P collides with the intermediary transfer belt 21 in some instances. By this, an image defect occurs at the trailing end portion of the recording material P with respect to the feeding direction in some instances. This phenomenon becomes conspicuous in the case where the rigidity of the recording material P is large since due to storing resilience of the recording material P, the trailing end portion of the recording material P with respect to the feeding direction is liable to vigorously collide with the intermediary transfer belt 21.

That is, as described above, in the cross section shown in FIG. 2, in a state in which the recording material P is nipped between the inner roller 26 and the outer roller 41 in the secondary transfer nip N2, there is a tendency that the recording material P is liable to maintain the attitude thereof substantially along the nip line Ln. For that reason, in general, the nip line Ln approaches and contacts the pre-nip stretching line T as with respect to the direction along the pre-nip stretching line T, the rotation center of the outer roller 41 is disposed on a side more upstream than the rotation center of the inner roller 26 in the rotational direction of the recording material P. As a result, when the trailing end of the recording material P with respect to the feeding direction passed through the feeding guide 27, as shown by a broken line B in FIG. 2, the trailing end portion of the recording material P collides with the intermediary transfer belt 21, so that the image defect is liable to occur at the trailing end portion of the recording material P with respect to the feeding direction. On the other hand, in general, when the rotation center of the inner roller 26 and the rotation center of the outer roller 41 are brought near to each other with respect to the direction along the pre-nip stretching line T, collision of the recording material P with the intermediary transfer belt 21 when the trailing end of the recording material P with respect to the feeding direction passed through the feeding guide 27 is suppressed. By this, the image defect at the trailing end portion of the recording material P with respect to the feeding direction does not readily occur.

Accordingly, in order to realize improvement in separating property of the recording material P from the intermediary transfer belt 21 and suppression of the image defect at the trailing end portion of the recording material P with respect to the feeding direction, the following is effective. That is, depending on the kind of the recording material P, a relative position between the inner roller 26 and the outer roller 41 with respect to a circumferential direction of the inner roller 26 (the rotational direction of the intermediary transfer belt 21) is changed, so that the shape (position) of the secondary transfer nip N2 is changed.

With reference to FIG. 2, definition of an offset amount X indicating the relative position between the inner roller 26 and the outer roller 41 will be described. In the cross section shown in FIG. 2, a common tangential line of the inner roller 26 and the pre-secondary transfer roller 29 on a side where the intermediary transfer belt 21 is extended around the stretching rollers is a reference line L1. The reference line L1 corresponds to the pre-nip stretching line T. Further, in the same cross section, a rectilinear line which passes through the rotation center of the inner roller 26 and which is substantially perpendicular to the reference line L1 is referred to as an inner roller center line L2. Further, in the same cross section, a rectilinear line which passes through the rotation center of the outer roller 41 and which is substantially perpendicular to the reference line L1 is referred to as an outer roller center line L3. At this time, a distance (vertical distance) between the inner roller center line L2 and the outer roller center line L3 is the offset amount X (in this case, the offset amount X is a positive value when the outer roller center line L3 is on the side upstream of the inner roller center line L2 with respect to the rotational direction of the intermediary transfer belt 21. The offset amount X can be a negative value, zero and the positive value. By making the offset amount X large, a width of the secondary transfer nip N2 with respect to the rotational direction of the intermediary transfer belt 21 extends toward an upstream side of the rotational direction of the intermediary transfer belt 21. That is, with respect to the rotational direction of the intermediary transfer belt 21, an upstream end portion of a contact region between the outer roller 41 and the intermediary transfer belt 21 is positioned on an upstream side than an upstream end portion of a contact region between the inner roller 26 and the intermediary transfer belt 21 is. Thus, by changing a position of at least one of the inner roller 26 and the outer roller 41, the relative position between the inner roller 26 and the outer roller 41 with respect to the circumferential direction of the inner roller 26 is changed, so that the position of the secondary transfer nip (transfer portion) N2 is changeable.

In FIG. 2, the outer roller 41 is illustrated so as to virtually contact the reference line L1 (pre-nip stretching line T) without being deformed. However, a material of an outermost layer of the outer roller 41 is an elastic member such as a rubber or a sponge, so that in actuality, the outer roller 41 is pressed and deformed toward the inner roller 26 by the urging spring 44. When the outer roller 41 is offset and disposed toward the upstream side with respect to the rotational direction of the intermediary transfer belt 21 relative to the inner roller 26 and is pressed by the urging spring 44 so as to nip the intermediary transfer belt 21 between itself and the inner roller 26, the secondary transfer nip N2 in a substantially S shape is formed. Further, the attitude of the recording material P guided and sent to the feeding guide 27 is also determined in conformity to the shape of the secondary transfer nip N2. With an increasing offset amount X, a bending amount of the recording material P increases. For that reason, for example, in the case where the recording material P is the “thin paper”, by making the offset amount X large, the separating property of the recording material P, from the intermediary transfer belt 21, passed through the secondary transfer nip N2 can be improved. However, when the offset amount X is large, the bending amount of the recording material P is large, so that in the case where for example, the recording material P is the “thick paper”, when the trailing end of the recording material P with respect to the recording material feeding direction passed through the feeding guide 27, the collision of the trailing end portion of the recording material P with respect to the recording material feeding direction with the intermediary transfer belt 21 is liable to occur. This causes a lowering in image quality of the trailing end portion of the recording material P with respect to the recording material feeding direction. For this reason, in this case, it may only be required that the offset amount X is made small.

In this embodiment, the image forming apparatus 100 changes the offset amount X by changing the position of at least one of the inner roller 26 or the outer roller 41. Particularly, in this embodiment, the image forming apparatus 100 changes the offset amount X on the basis of information on a basis weight of the recording material (paper) P as information on the kind of the recording material P relating to rigidity of the recording material P. For example, in the case where the recording material P is the “thick paper”, the inner roller 26 is disposed in a first inner roller position where the offset amount X is a first offset amount X1. Further, in the case where the recording material P is the “thin paper”, the inner roller 26 is disposed in a second inner roller position where the offset amount X is a second offset amount X2 larger than the first offset amount X1. The first offset amount X1 may be a positive value, zero and a negative value, and the second offset amount X2 is typically a positive value. In this embodiment, the relative position between the inner roller 26 and the outer roller 41 in the case where the offset amount X is the first offset amount X1 is a first relative position, and the relative position between the inner roller 26 and the outer roller 41 in the case where the offset amount X is the second offset amount X1 is a second relative position. In other words, the position of the secondary transfer nip N2 in the case where the offset amount X is the first offset amount X1 is a first position of the transfer portion, and the position of the secondary transfer nip N2 in the case where the offset amount X is the second offset amount X2 is a second position of the transfer portion.

### 3. Offset Mechanism

An offset mechanism 101 in this embodiment will be described. In this embodiment, the “thin paper” is used as an example of the recording material P small in rigidity, and the “thick paper” is used as an example of the recording material P large in rigidity. Parts (a) and (b) of FIG. 3 are schematic side views of a principal part of the neighborhood of the secondary transfer nip N2 in this embodiment as seen substantially in parallel to the rotational axis direction on one end portion side (the front (surface) side in FIG. 1) with respect to the rotational axis direction of the inner roller 26. Part (a) of FIG. 3 shows a state of the case of the “thick paper”, and part (b) of FIG. 3 shows a state of the case of the “thin paper”. Incidentally, for example, the cases of the “thin paper” and the “thick paper” refer to the cases where the “thin paper” and the “thick paper” pass through the secondary transfer nip N2.

As shown in parts (a) and (b) of FIG. 3, in this embodiment, the image forming apparatus 100 includes the offset mechanism (offset amount changing mechanism) 101 as a position changing mechanism for changing the offset amount by changing the relative position of the inner roller 26 to the outer roller 41. In parts (a) and (b) of FIG. 3, a structure of the inner roller 26 at one end portion of the inner roller 26 with respect to the rotational axis direction is shown, but a structure of the inner roller 26 at the other end portion is also the same (i.e., these (opposite) end portions are substantially symmetrical to each other with respect to a center of the inner roller 26 with respect to the rotational axis direction).

The opposite end portions of the inner roller 26 with respect to the rotational axis direction are rotatably supported by an inner roller holder 38 as a supporting member. The inner roller holder 38 is supported by a frame or the like of the intermediary transfer belt unit 20 so as to be rotatable about an inner roller rotation shaft 38a. Thus, the inner roller holder 38 is rotated about the inner roller rotation shaft 38a, so that the inner roller 26 is rotated about the inner roller rotation shaft 38a, so that the relative position of the inner roller 26 to the outer roller 41 is changed and thus the offset amount X can be changed.

The inner roller holder 38 is constituted so as to be rotated by the action of an offset cam 39 as an acting member. The offset cam 39 is supported by the frame or the like of the intermediary transfer belt unit 20 so as to be rotatable about the offset cam rotation shaft 39a. The offset cam 39 is rotatable about the offset cam rotation shaft 39a by receiving the driving force (drive) from an offset cam driving motor 113 as a driving source. Further, the offset cam 39 contacts an offset cam follower (arm portion) 38c provided as a part of the inner roller holder 38. Further, the inner roller holder 38 is urged by tension of the intermediary transfer belt 21 in this embodiment as described later so that the offset cam follower 38c rotates in a direction in which the offset cam follower 38c engages with the offset cam 39. However, the present invention is not limited thereto, but the inner roller holder 38 may also be urged by a spring or the like which is an urging member (elastic member) as an urging means so that the offset cam follower 38c rotates in a direction in which the offset cam follower 38c engages with the offset cam 39. Further, in this embodiment, the image forming apparatus 100 is provided with an offset cam position sensor 37, for detecting the position of the offset cam 39 with respect to the rotational direction, as a detecting means for detecting the relative position between the inner roller 26 and the outer roller 41 (i.e., the position of the inner roller 26 in this embodiment). The offset cam position sensor 37 can be constituted by, for example, a flag provided on or coaxially with the offset cam 39 and a photo-interrupter or the like as a detecting portion.

Thus, in this embodiment, the offset mechanism 101 is constituted by including the inner roller holder 38, the offset cam 39, the offset cam driving motor 113, the offset cam position sensor 37 and the like.

As shown in part (a) of FIG. 3, in the case of the “thick paper”, the offset cam 39 is rotated, for example, clockwise by being driven by the offset cam driving motor 113. By this, the inner roller holder 38 is rotated counterclockwise about the inner roller rotation shaft 38a, so that the relative position of the inner roller 26 to the outer roller 41 is determined. By this, the inner roller 26 is disposed in a state in which the inner roller 26 is in the first inner roller position where the offset amount X is the first offset amount X1 relatively small. Further, a degree of bending of the recording material P in the secondary transfer nip N2 can be reduced. As a result, as described above, it is possible to suppress a lowering in image quality at the trailing end portion of the recording material P with respect to the feeding direction of the “thick paper”.

As shown in part (b) of FIG. 3, in the case of the “thin paper”, the offset cam 39 is rotated, for example, counterclockwise by being driven by the offset cam driving motor 113. By this, the inner roller holder 38 is rotated clockwise about the inner roller rotation shaft 38a, so that the relative position of the inner roller 26 to the outer roller 41 is determined. By this, the inner roller 26 is disposed in a state in which the inner roller 26 is in the second inner roller position where the offset amount X is the second offset amount X2 relatively large. Further, the recording material P is liable to bend in the secondary transfer nip N2. As a result, as described above, the separating property of the “thin paper”, from the intermediary transfer belt 21, passed through the secondary transfer nip N2 is improves.

In this embodiment, on the basis of a basis weight M (gsm) of the recording material P, the offset amounts X (X1, X2) are set at, for example, the following two patterns. Incidentally, “gsm” means g/m².

(a) M≥52 gsm: X1=−1.3 mm

(b) M<52 gsm: X2=+2.5 mm

In this embodiment, the position (the relative position between the inner roller 26 and the outer roller 41) of the inner roller 26 in the above setting (a) shown in part (a) of FIG. 3 is a home position of the inner roller 26 (the relative position between the inner roller 26 and the outer roller 41). Here, the home position refers to a position when the image forming apparatus 100 is in a sleep state (described later) or when a main switch (main power source) is turned off. However, the present invention is not limited thereto, but the position of the inner roller 26 in the above setting (b) shown in part (b) of FIG. 3 may also be the home position.

The offset amount X and the kind (the basis weight of the recording material P in this embodiment) of the recording material P assigned to the offset amount X are not limited to the above-described specific examples. These values can be appropriately set through an experiment or the like from viewpoints such as the improvement in separating property of the recording material P from the intermediary transfer belt 21 and the suppression of the image defect occurring in the neighborhood of the secondary transfer nip N2. The present invention is not limited thereto, but the offset amount X may suitably be about −3 mm to about +3 mm. By such settings, a good transfer property can be obtained.

The patterns of the offset amount X are not limited to the two patterns, but may also be set at three or more patterns. Further, in conformity with this embodiment, a proper setting can be selected from the settings of the three or more patterns on the basis of the information or the like on the basis weight of the recording material P as the information on the kind of the recording material P relating to the rigidity of the recording material P.

Here, in this embodiment, in the cross sections shown in parts (a) and (b) of FIG. 3, to the inner roller holder 38, counterclockwise moment about the inner roller rotation shaft 38a is always exerted by the tension of the intermediary transfer belt 21. That is, in this embodiment, by the tension of the intermediary transfer belt 21, moment in a direction in which the offset cam follower 38c rotates so as to engage with the offset cam 39 is always exerted on the inner roller holder 38. Further, in this embodiment, in the cross-section shown in parts (a) and (b) of FIG. 3, the inner roller rotation shaft 38a is disposed on a side downstream, with respect to the feeding direction of the recording material P, of the rectilinear line (nip center line) Lc connecting the rotation center of the inner roller 26 and the rotation center of the outer roller 41. By this, in the case where the outer roller 41 is contacted to the intermediary transfer belt 21 toward the inner roller 26, reaction force received by the inner roller holder 38 from the outer roller 41 also constitutes the counterclockwise moment in parts (a) and (b) of FIG. 3. By such a constitution, the cam mechanism can be constituted without separately using an urging member such as a spring.

Further, in order to exchange the intermediary transfer belt 21, the inner roller holder 38 may desirably be disposed inside the stretching surface of the intermediary transfer belt 21 so as not to impair operativity of an operation in which the intermediary transfer belt 21 is mounted in or dismounted from the intermediary transfer belt unit 20. For that reason, in the cross section shown in parts (a) and (b) of FIG. 3, the inner roller rotation shaft 38a may desirably be disposed in a region A between the above-described rectilinear line (nip center line) Lc and a post-nip stretching line U. Here, the post-nip stretching line U is a line indicating the stretching surface of the intermediary transfer belt 21 stretched and formed by the inner roller 26 and the driving roller 22 (FIG. 1) in the cross section shown in parts (a) and (b) of FIG. 3. Incidentally, the driving roller 22 is an example of the downstream rollers, of the plurality of stretching rollers, disposed downstream of and adjacent to the inner roller 26 with respect to the rotational direction of the intermediary transfer belt 21.

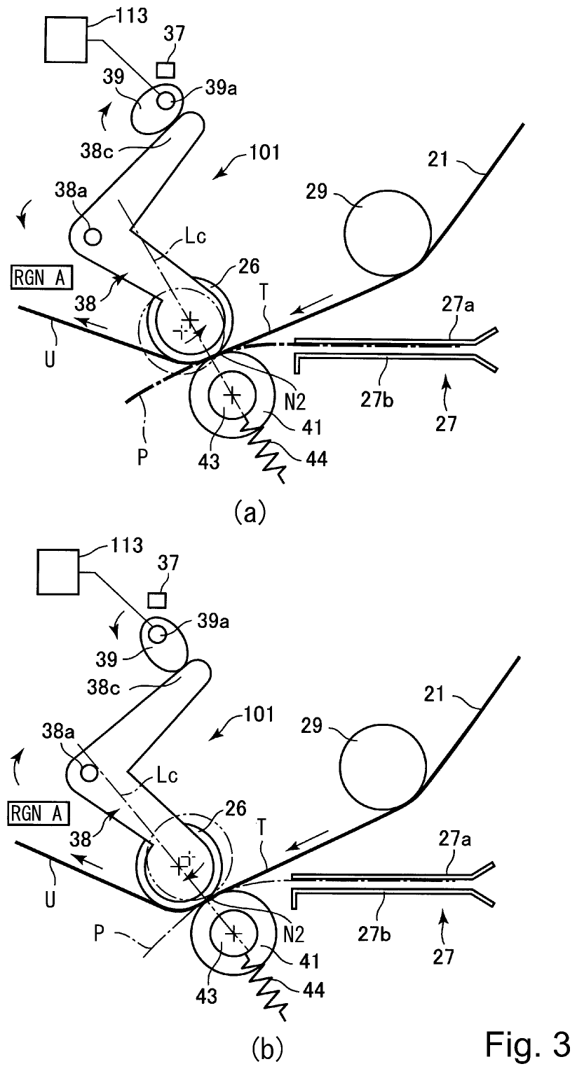

FIG. 4 is a schematic side view of the inner roller holder 38 and the neighborhood thereof as seen in substantially parallel to the rotational axis direction of the inner roller 26 on the one end portion side (the front side on the drawing sheet of FIG. 1) with respect to the rotational axis direction. A state shown by a solid line in FIG. 4 is a state of the position of the inner roller 26 corresponding to the “thick paper”. In this state, as described above, by the tension of the intermediary transfer belt 21 and the reaction force received from the outer roller 41, the inner roller holder 38 receives the counterclockwise moment about the inner roller rotation shaft 38a. Then, a cylindrical abutment portion 38b provided as a part of the inner roller holder 38 coaxially with the inner roller 26 abuts against a first positioning portion 40a. By this, the inner roller 26 is positioned in a position of the first offset amount X1 (=−1.3 mm). A state shown by a chain double-dashed line in FIG. 4 is a state of the case of the “thin paper”. The offset cam 39 is rotated and contacts and presses the arm portion 38c of the inner roller holder 38, so that the inner roller holder 38 is rotated clockwise about the inner roller rotation shaft 38a. Then, the abutment portion 38b abuts against a second positioning portion 40b. By this, the inner roller 26 is positioned in a position of the second offset amount X2 (=+2.5 mm). Incidentally, the first and second positioning portions 40a and 40b are provided on the frame or the like of the intermediary transfer belt unit 20.

### 4. Surface Speed Ratio and Image Abrasion

Next, a surface speed ratio and an image abrasion between the intermediary transfer belt 21 and the recording material P in the secondary transfer nip N2 will be described.

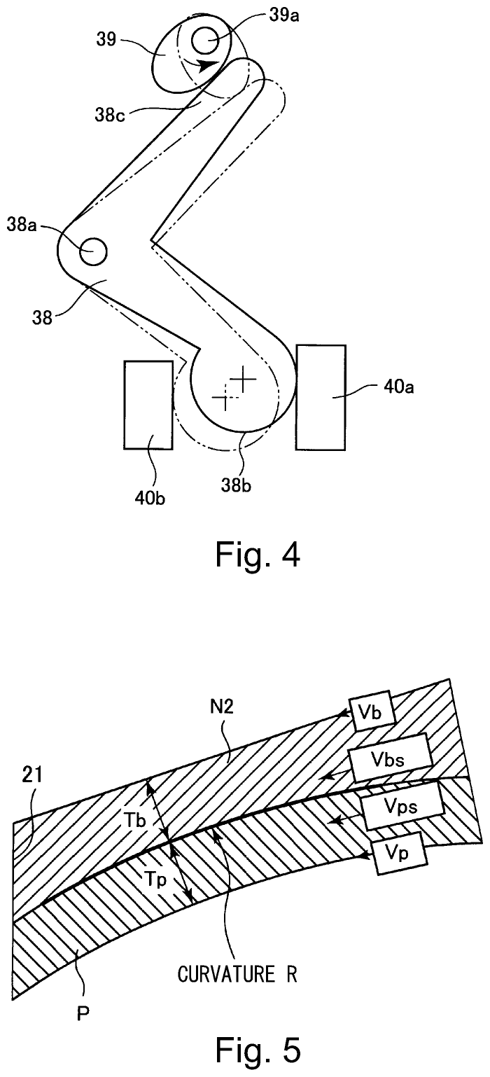

FIG. 5 shows a schematic cross section (cross section substantially perpendicular to the rotational axis direction of the inner roller 26) of the intermediary transfer belt 21 and the recording material P in the secondary transfer nip N2.

A feeding speed of the intermediary transfer belt 21 is Vb, a feeding speed of the recording material P is Vp, a surface speed of the intermediary transfer belt 21 in the secondary transfer nip N2 is Vbs, a surface speed of the recording material P in the secondary transfer nip N2 is Vps, a thickness of the intermediary transfer belt 21 is Tb, and a thickness of the recording material P is Tp.

Here, the feeding speed Vb of the intermediary transfer belt 21 is a moving speed of the inner peripheral surface (back surface) of the intermediary transfer belt 21. Further, the feeding speed Vb of the intermediary transfer belt 21 can be specifically represented by a driving speed of the intermediary transfer belt 21 by the belt driving portion 112, more specifically represented by a peripheral speed (rotational speed, the number of rotations per unit time) of the driving roller 22. Further, the feeding speed Vp of the recording material P is a moving speed of a surface (back surface) of the recording material P on a side where the recording material P contacts the outer roller 41. Further, the feeding speed Vp of the recording material P can be specifically represented by a driving speed of the registration roller 13 by the registration (roller) driving portion 114, more specifically represented by a peripheral speed (rotational speed, the number of rotations per unit time of the registration roller 13. Further, the surface speed Vbs of the intermediary transfer belt 21 in the secondary transfer nip N2 is a moving speed of the outer peripheral surface (front surface) of the intermediary transfer belt 21 in the secondary transfer nip N2. Further, the surface speed Vps of the recording material P in the secondary transfer nip N2 is a moving speed of the surface (front surface) of the recording material P on a side where the recording material P contacts the intermediary transfer belt 21 in the secondary transfer nip N2.

As described above, in the secondary transfer nip N2, the intermediary transfer belt 21 and the recording material P are pressed by the (secondary transfer) outer roller 41, so that a bent shape is formed. Curvature due to this bending is R.

At this time, a surface speed ratio Vps/Vbs between the surface speed Vbs of the intermediary transfer belt 21 and the surface speed Vps of the recording material P in the secondary transfer nip N2 is represented by the following formula (1).

Vps/Vbs={1±(Tb+Tp)}×R×(Vp/Vb) (1)

From the above formula (1), it is understood that the surface speed ratio Vps/Vb becomes larger with an increasing curvature R.

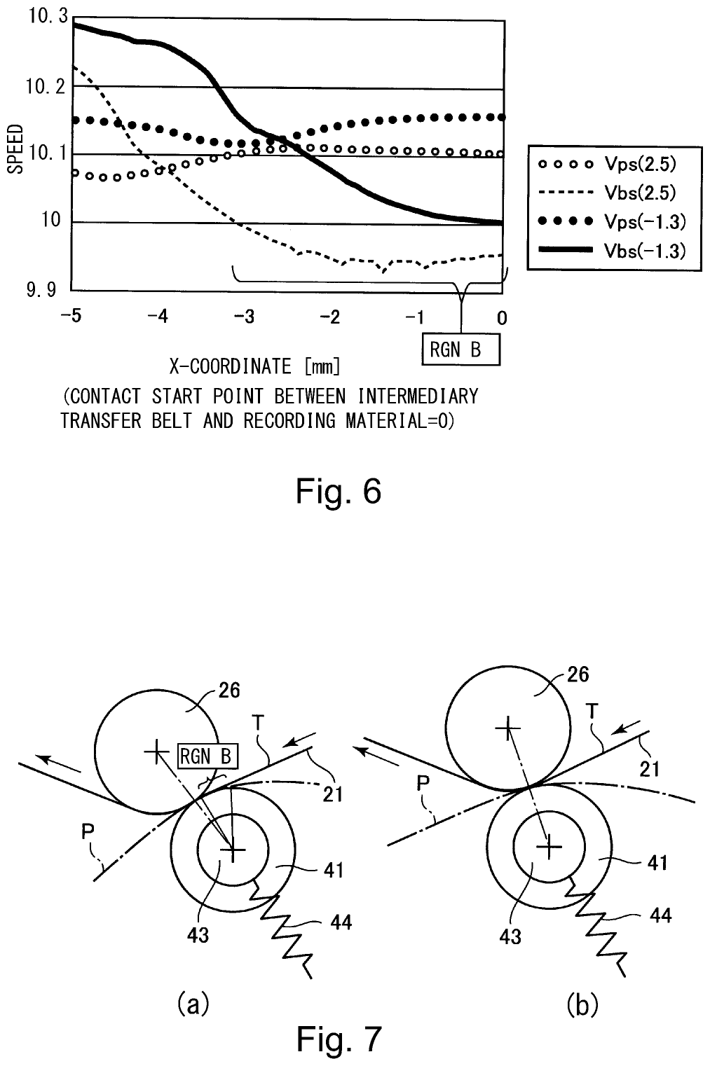

FIG. 6 is a graph showing a difference in surface speed, due to a difference in offset amount X, between the recording material P and the intermediary transfer belt 21 in each of positions at a periphery of the secondary transfer nip N2. The abscissa of FIG. 6 represents a coordinate (of which sign is minus on a downstream side of the feeding direction of the recording material P) of the feeding direction of the recording material P in the case where a contact start point between the intermediary transfer belt 21 and the recording material P is 0. The ordinate of FIG. 6 represents the surface speed Vps of the recording material P and the surface speed Vbs of the intermediary transfer belt 21 in each of the coordinates. Vps (2.5) and Vps (−1.3) represent the surface speeds Vps of the recording material P in the case where the offset amounts X are +2.5 mm and −1.3 mm, respectively. Further, Vbs (2.5) and Vbs (−1.3) represent the surface speeds Vbs of the intermediary transfer belt 21 in the case where the offset amounts X are +2.5 mm and −1.3 mm, respectively. Further, in FIG. 6, each of the surface speed Vps of the recording material P and the surface speed Vbs of the intermediary transfer belt 21 is represented by a speed ratio in the case where an associated speed in an outside (condition in which bending is not formed) of the secondary transfer nip N2 is set at a reference speed 10. That is, each of the surface speeds Vps and Vbs is represented by a speed ratio in the case where the surface speeds Vps and Vbs in positions where the surface speeds Vps and Vbs are regards as being nearly equal to Vp and Vb, respectively. Further, in FIG. 6, the driving speed Vp of the registration roller 13 is a certain value irrespective of the offset amount X and is a value slightly larger than the driving speed Vb of the intermediary transfer belt 21.

The value Vbs (2.5) is below 10 in a section from the contact start point between the intermediary transfer belt 21 and the recording material P to the neighborhood of 3 mm from the contact start point toward a downstream side of the feeding direction of the recording material P. This is for the following reason. Part (a) of FIG. 7 is a schematic sectional view (cross section substantially perpendicular to the rotational axis direction of the inner roller 26) for illustrating a shape of the secondary transfer nip N2 in the case where the offset amount X is a positive value. In the case where the offset amount X is the positive value, i.e., in the case where the outer roller center line L3 is positioned on a side upstream of the inner roller center line L2, the following shape is formed. That is, a contact region (region B in part (a) of FIG. 7) between the outer roller 41 and the intermediary transfer belt 21 on a side upstream of a contact start point between the inner roller 26 and the intermediary transfer belt 21 with respect to the rotational direction of the intermediary transfer belt 21 expands. In this region B, a nip shape of the outer peripheral surface of the intermediary transfer belt 21 is provided with the curvature R about the outer roller 41. For that reason, the surface speed Vbs becomes low speed correspondingly to a thickness of the intermediary transfer belt 21 due to the influence of the curvature in the secondary transfer nip N2, particularly in the above-described region B, so that progression of the surface speed Vbs as shown in FIG. 6 is provided.

On the other hand, the value Vbs (−1.3) progresses with 10 or more. This is for the following reason. Part (b) of FIG. 7 is a schematic sectional view (cross section substantially perpendicular to the rotational axis direction of the inner roller 26) for illustrating a shape of the secondary transfer nip N2 in the case where the offset amount X is 0 or a negative value (particularly, the negative value). In the case where the offset amount X is 0 or the negative value (particularly, the negative value), i.e., in the case where the outer roller center line L3 is positioned on the same position as or on a side downstream of the inner roller center line L2, there is no region B as in the case of part (a) of FIG. 7. That is, there is no region in which a nip shape of the outer peripheral surface of the intermediary transfer belt 21 is provided with the curvature R about the outer roller 41. Instead, the nip shape of the surface of the intermediary transfer belt 21 is provided with the curvature R about the inner roller 26. For that reason, the surface speed Vbs becomes high speed correspondingly to a thickness of the intermediary transfer belt 21 due to the influence of the curvature in the secondary transfer nip N2, so that progression of the surface speed Vbs as shown in FIG. 6 is provided.

On the other hand, as shown in FIG. 6, as regards the surface speed Vps, due to a small influence of the thickness or the like, there is no speed change in the secondary transfer nip N2 compared with the case of the surface speed Vbs, and the difference due to the offset amount X is also small relative to the surface speed Vbs.

From the above, it is understood that the surface speed ratio Vps/Vbs in the secondary transfer nip N2 is different depending on the offset amount X. This is because a fluctuation of the surface speed Vbs of the intermediary transfer belt 21 by the offset amount X in the secondary transfer nip N2 is relatively large and on the other hand, a fluctuation of the surface speed Vps of the recording material P by the offset amount X in the secondary transfer nip N2 is small. Particularly, in the case where the offset amount X is the positive value, the surface speed ratio Vps/Vbs becomes larger, and therefore, “image abrasion” which is an image defect such that a toner image is abraded, resulting from the speed difference between the surface speed of the intermediary transfer belt 21 and the surface speed of the recording material (paper) P is liable to occur.

In the case where the intermediary transfer belt 21 including the elastic layer is used, a tendency as described above is liable to become more conspicuous since the nip shape of the intermediary transfer belt 21 is liable to be provided with the curvature and the thickness of the intermediary transfer belt 21 is relatively large. Incidentally, in this embodiment, the case where the offset amount X is the positive value and the case where the offset amount X is 0 or the negative value are described in a comparison manner, but there is a similar tendency (such that with an increasing offset amount X, the surface speed Vbs becomes a lower speed and the surface speed ratio Vps/Vbs becomes larger) between offset amounts X which are different positive values.

Therefore, in this embodiment, depending on the offset amount X, the image forming apparatus 100 changes a ratio Vp/Vb between the feeding speed Vb of the intermediary transfer belt 21 and the feeding speed Vp of the recording material P (this ratio is also simply referred to as a “feeding speed ratio”). As described above, the feeding speed Vb of the intermediary transfer belt 21 can be represented by a driving speed of the intermediary transfer belt 21 by the belt driving portion 112, and the feeding speed of the recording material P can be represented by a driving speed of the registration roller 13 by the registration (roller) driving portion 114. For that reason, the feeding speed ratio can also be called a ratio Vp/Vb between the driving speed Vb of the intermediary transfer belt 21 by the belt driving portion 112 and the driving speed Vp of the registration roller 13 by the registration driving portion 114 (this ratio is also simply referred to as a “drive speed ratio”). Particularly, in this embodiment, in the image forming apparatus 100, the feeding speed Vb of the intermediary transfer belt 21 is set at the same speed (substantially constant speed) even when the basis weight of the recording material P is changed in the case where the basis weight falls within a predetermined range. In this embodiment, when the basis weight of the recording material P is not more than a predetermined basis weight (300 gsm), the feeding speeds Vb of the intermediary transfer belt 21 are set at the same value between the “thin paper” and the “thick paper”. Further, in this embodiment, in the case where the feeding speeds Vb are the substantially same speed, the feeding speed ratio Vp/Vb is changed by changing the feeding speed Vp of the recording material P depending on the offset amount X. The image is forming apparatus 100 can make the feeding speed ratio Vp/Vb substantially the same by changing the feeding speed Vp of the recording material P when the offset amount X is substantially the same even in the case where the feeding speed Vb of the intermediary transfer belt 21 is different. Specifically, in this embodiment, in the case where the offset amount X changes from a first offset amount X1 to a second offset amount X2 larger than the first offset amount X1, the feeding speed ratio Vp/Vb when the offset amount X is the second offset amount X2 is made smaller than the feeding speed ratio Vp/Vb when the offset amount X is the first offset amount X1. Particularly, in this embodiment, in the case where the feeding speed Vb of the intermediary transfer belt 21 is substantially the same, the image forming apparatus 100 makes the feeding speed

Vp of the recording material P (the driving speed Vp of the registration roller 13) when the offset amount X is the second offset amount X2, smaller than the feeding speed Vp of the recording material P (the driving speed Vp of the registration roller 13) when the offset amount X is the first offset amount X1. By this, the feeding speed ratio Vp/Vb when the offset amount X is the second offset amount X2 is made a lower speed than the feeding speed ratio Vp/Vb when the offset amount X is the first offset amount X1. More specifically, in this embodiment, the feeding speed Vp (2.5) of the recording material P when the offset amount X is +2.5 mm (second offset amount X2) is made a lower speed than the feeding speed Vp (−1.3) of the recording material P when the offset amount X is −1.3 mm (first offset amount X1). Further, a feeding speed ratio Vp (2.5)/Vb (2.5) when the offset amount X is +2.5 mm is made smaller than a feeding speed ratio Vp (−1.3)/Vb (−1.3) when the offset amount X is −1.3 mm. By this, a fluctuation in surface speed ratio Vps/Vbs in the secondary transfer nip N2 due to a change in offset amounts X (X1, X2), so that the “image abrasion” is suppressed.

Herein, the feeding speed (the driving speed of the registration roller 13) Vp of the recording material P is also referred to as a “registration speed”. Further, the feeding speed (the driving speed) Vp of the intermediary transfer belt 21 is also referred to as a “process speed”. In this embodiment, the registration speed Vp is set every process speed so that a value thereof when the offset amount X is the first offset amount X1 corresponding to the home position of the inner roller 26 is a default (value). Further, in this embodiment, the process speed Vb is set at a constant speed as the default.

Incidentally, in the case where the registration speed is changed from the default, a magnification fluctuation of the image with respect to the recording material feeding direction occurs during the secondary transfer. For that reason, in this embodiment, the controller 150 (FIG. 8) makes correction so as to suppress the magnification fluctuation by correcting information, of digital image information (image data) sent to the image forming apparatus 100, on a magnification of the image with respect to the recording material feeding direction. Herein, this correction is also referred to as a “digital registration correction”. Incidentally, a specific method itself of the digital registration correction can be appropriately selected from known available methods, for example. Roughly, in the case where the registration speed is decreased, the magnification of the image with respect to the feeding direction is reduced during the secondary transfer, so that the magnification of the image, with respect to the feeding direction, formed on the intermediary transfer belt 21 may only be required to be increased in advance. On the other hand, in the case where the registration speed is increased, the magnification of the image with respect to the feeding direction is increased during the secondary transfer, so that the magnification of the image, with respect to the feeding direction, formed on the intermediary transfer belt 21 may only be required to be reduced in advance.

In this embodiment, the image forming apparatus 100 is operable at a constant speed and a half speed as the process speed Vb. At the constant speed, the process speed Vb is 345.9 mm/s and the registration speed Vp is 348.0 mm. At the half speed, the process speed Vb is 172.9 mm/s and the registration speed Vp is 174.0 mm. Incidentally, in this embodiment, Tb is 355 um and Tp is 100 um. A table 1 shows a result (at the constant speed) such that in the constitution of this embodiment, an actual printing operation was performed and then occurrence or non-occurrence of the “image abrasion” was checked by eye observation.

TABLE 1

| OFFSET | REGISTRATION | PROCESS | | |
|---|---|---|---|---|
| AMOUNT | SPEED | SPEED | | |
| X | Vp | Vb | | IMAGE |
| (mm) | (mm/s) | (mm/s) | Vp/Vb | ABRASION |
| +2.5 | 348.0 | 345.9 | 1.006 | OCCURRED |
| +2.5 | 344.5 | 345.9 | 0.996 | NOT OCCURRED |
| −1.3 | 348.0 | 345.9 | 1.006 | NOT OCCURRED |

As is understood from the table 1, for example, at the constant speed, in the case where the offset amount X is +2.5 mm (second offset amount X2), when the registration speed Vp is the default (348.0 mm/s), the “image abrasion” occurred. Accordingly, in this embodiment, control such that the registration speed Vp is changed so as to suppress the “image abrasion” and thus the feeding speed ratio Vp/Vb is changed is carried out.

### 5. Control Mode

FIG. 8 is a schematic block diagram showing a control mode of a principal part of the image forming apparatus 100 in this embodiment. The controller 150 as a control means is constituted by including a CPU 151 as a calculation control means which is a dominant element for performing processing, memories (storing media) 152 such as a ROM and a RAM which are used as storing means, and an interface portion 153 and the like. In the RAM which is rewritable memory, information inputted to the controller 150, detected information, a calculation result and the like are stored. In the ROM, a data table acquired in advance and the like are stored. The CPU 151 and the memories 152 are capable of transferring and reading the data therebetween. The interface portion 153 controls input and output (communication) of signals between the controller 150 and devices connected to the controller 150.

To the controller 150, respective portions (the image forming portions 10, the intermediary transfer belt 21, driving devices for the members relating to feeding of the recording material P, various voltage sources and the like) of the image forming apparatus 100 are connected. For example, to the controller 150, the offset mechanism 101, the drum driving portion 111, the belt driving portion 112, the registration roller driving portion 114, various high-voltage sources (for the charging voltage, the developing voltage, the primary transfer voltage and the secondary transfer voltage) and the like are connected. Further, to the controller 150, signals (output values) indicating detection results of the various sensors such as the offset cam position sensor 37 are inputted. An output value of the offset cam position sensor 37, i.e., the information on the position (relative position between the inner roller 26 and the outer roller 41) of the inner roller 26 is stored in the memory 152. Further, to the controller 150, the operating portion (operating panel) 160 provided on the image forming apparatus 100 is connected. The operating portion 160 includes a display means for displaying information by control of the controller 150 and an input means for inputting information to the controller 150 through an operation by an operator such as a user or a service person. The operating portion 160 may be constituted by including a touch panel having functions of the display means and the input means. Further, to the controller 150, an image reading apparatus (not shown) provided in or connected to the image forming apparatus and an external device 200 such as a personal computer connected to the image forming apparatus 100 may also be connected.

The controller 150 causes the image forming apparatus 100 to form the image by controlling the respective portions of the image forming apparatus 100 on the basis of information on a job. The job information includes a start instruction (start signal) and information (instruction signal) on a printing operation condition such as a kind of the recording material P, which are inputted from the operating portion 160 or the external device 200. Further, the job information includes image information (image signals) inputted from the external device 200 or the operating portion 160. Incidentally, information on the kind of the recording material (this information is also simply referred to as “information on the recording material” encompasses arbitrary pieces of information capable of discriminating the recording material, inclusive of attributes (so-called paper kind categories) based on general features such as plain paper, quality paper, coated paper, embossed paper, thick paper and thin paper, numerals and numerical ranges such as a basis weight, a thickness and a size, and brands (including manufactures, product numbers and the like). In this embodiment, the information on the kind of the recording material P includes information on the kind of the recording material P relating to the rigidity of the recording material P, particularly information on the basis weight of the recording material P as an example. In the case where the information on the printing operation condition is inputted from the operating portion 160, the operating portion 160 functions as an inputting portion for inputting to the controller 150, the information on the basis weight of the recording material P onto which the toner image is transferred. Further, in the case where the information on the printing operation condition is inputted from the external device 200 such as the personal computer, the interface portion 153 functions as the inputting portion for inputting, to the controller 150, the information on the basis weight of the recording material P onto which the toner image is transferred.

Here, the image forming apparatus 100 executes a job (printing job, print job) which is a series of operations which is started by a single start instruction and in which the image is formed and outputted on a single recording material P or a plurality of recording materials P. The job includes an image forming step (printing operation, print operation, image forming operation), a pre-rotation step, a sheet (paper) interval step in the case where the images are formed on the plurality of recording materials P, and a post-rotation step is general. The image forming step is performed in a period in which formation of an electrostatic image for the image actually formed and outputted on the recording material P, formation of the toner image, primary transfer of the toner image and secondary transfer of the toner image are carried out. Specifically, timing during the image formation is different among positions where the respective steps of the formation of the electrostatic image, the toner image formation, the primary transfer of the toner image and the secondary transfer of the toner image are performed. The pre-rotation step is performed in a period in which a preparatory operation, before the image forming step, from an input of the start instruction until the image is started to be actually formed. The sheet interval step is performed in a period corresponding to an interval between a recording material P and a subsequent recording material P when the images are continuously formed on a plurality of recording materials P (continuous image formation). The post-rotation step is performed in a period in which a post-operation (preparatory operation) after the image forming step is performed. During non-image formation (non-image formation period) is a period other than the period of the image formation and includes the periods of the pre-rotation step, the sheet interval step, the post-rotation step and further includes a period of a pre-multi-rotation step which is a preparatory operation during turning-on of a main switch (voltage source) of the image forming apparatus 100 or during restoration from a sleep state. Incidentally, the shape state (rest state) is a state is, for example, a state in which supply of electric power to the respective portions, of the image forming apparatus 100, other than the controller 150 (or a part thereof) is stopped and electric power consumption is made smaller than electric power consumption in the stand-by state. In this embodiment, during the non-image formation, the offset mechanism 101 performs an operation of changing the offset amount by changing the position of at least one of the inner roller 26 and the outer roller 41 (particularly the inner roller 26 in this embodiment) (this operation is also referred to as an “offset operation”).

### 6. Control Procedure

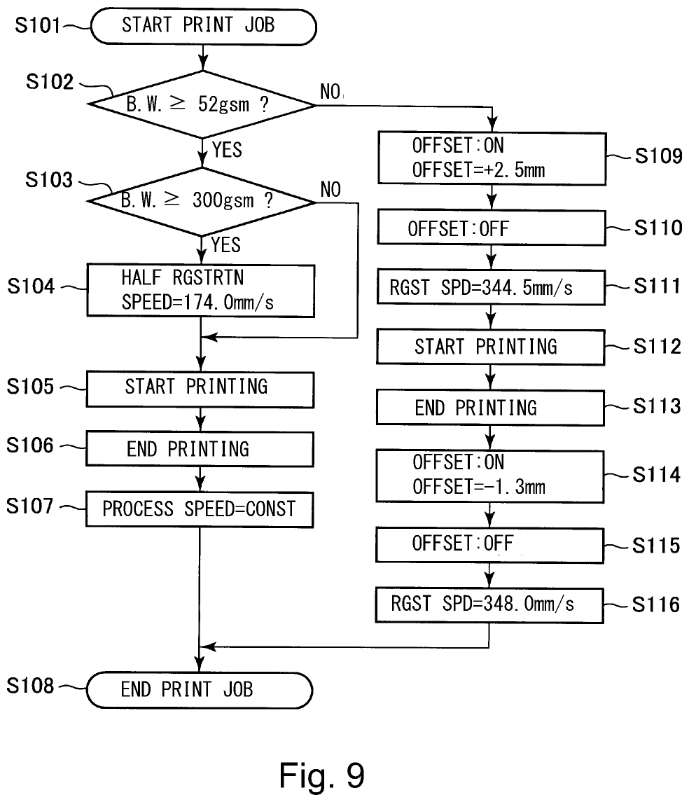

FIG. 9 is a flowchart showing an outline of an example of a control procedure of the job in this embodiment. In this embodiment, the case where a single job for forming an image on a single recording material P from a state in which the inner roller 26 is in the home position and the offset amount X is the first offset amount X1 will be described. Further, in this embodiment, the case where the operator causes the image forming apparatus 100 to execute the job through the operating portion 160 of the apparatus main assembly 110 will be described as an example. Incidentally, FIG. 9 shows the outline of the control procedure in which the offset operation and a change in registration speed are noticed, and other many operations needed in general to output the image by executing the job are omitted.

First, when the operator such as the user sets the job by operating the operating portion 160, information thereof is notified to the controller 150. The controller 150 causes the image forming apparatus 100 to start the job by providing an instruction to the respective portions of the image forming apparatus 100 on the basis of the information. The job information sent to the controller 150 includes the information on the kind of the recording material P. In this embodiment, the information on the kind of the recording material P includes at least the information on the basis weight of the recording material P. The information on the kind of the recording material P may also include, in addition to the information on the basis weight of the recording material P, pieces of information such as information on a surface property of the recording material P and information on an electric resistance value. Incidentally, the controller 150 is capable of acquiring the information on the kind of the recording material P directly inputted (also including selection from a plurality of choices) from the operating portion 160 (or the external device 200) through the operation by the operator. Further, the controller 150 is also capable of acquiring information on the kind of the recording material P, on the basis of the information on the recording material accommodating portion 11 for feeding the recording material P in the job, inputted from the operating portion 160 (or the external device 200) through the operation by the operator. In this case, the controller 150 is capable of acquiring the information on the kind of the recording material P from the pieces of information on the kinds of the recording materials P stored in the memories 152 associated in advance with the plurality of the recording material accommodating portions 11, respectively. Here, when the information on the kind of the recording material P is registered, an associated one may also be selected from a list of the kinds of the recording materials P stored in the memories 152 or a storing device connected to the controller 150 through a network in advance. When the controller 150 acquires the information on the kind of the recording material P used in the job, the controller 150 sets the printing operation condition of the job at a printing operation condition predetermined every kind of the recording material P. A table 2 shows an example of settings of the process speed, the offset amount and the registration speed which are preset depending on the basis weight of the recording material P as the printing operation condition in this embodiment. Pieces of information on the printing operation condition as shown in the table 2 are stored in advance in the memories 152.

TABLE 2

| BW*¹ | PS*² | OA*³ | RS*⁴ | |
|---|---|---|---|---|
| M | Vb | X | Vp | |
| (gsm) | (mm/s) | (mm) | (mm/s) | Vp/Vb |
| 48 | 345.9 (CS*⁵) | +2.5 | 344.5 | 0.996 |
| 81 | 345.9 (CS*⁵) | −1.3 | 348.0 | 1.006 |
| 350 | 172.9 (HS*⁶) | −1.3 | 174.0 | 1.006 |

*¹“BW” is the basis weight.
*²“PS” is the process speed.
*³“OA” is the offset amount.
*⁴“RS” is the registration speed.
*⁵“CS” is the constant speed.
*⁶“HS” is the half speed.

Next, the controller 150 discriminates whether or not the basis weight of the recording material P used in the job is 52 gsm (first threshold) offset mechanism (S102). In the case where the controller 150 discriminated in S102 that the basis weight is 52 gsm or more, the controller 150 does not change the offset amount X since the offset amount X may be kept at −1.3 mm (first offset amount X1) which is the default corresponding to the home position of the inner roller 26. Then, the controller 150 discriminates whether or not the basis weight of the recording material P used in the job is 300 gsm (second threshold) (S103). In the case where the controller 150 discriminated in S103 that the basis weight is less than 300 gsm, the controller 150 does not change the setting of the process speed in the memory 152 by keeping the process speed at the constant speed which is the default, and the sequence goes to a process of S105. On the other hand, in the case where the controller 150 discriminated in S103 that the basis weight is 300 gsm or more, the controller 150 changes the setting of the process speed in the memory 152 so that the process speed is changed from the constant speed which is the default to the half speed (S104). Further, in S104, the controller 150 changes the setting of the registration speed in the memory 152 so that the registration speed is changed to 174.0 mm/s which is the default for the process speed (half speed). Thereafter, the controller 150 starts the printing operation (S105), and then ends the printing operation after the printing operation of images on a predetermined number of sheets set by the operator for the printing operation is completed (S106). After the end of the printing operation, the controller 150 returns the setting of the process speed in the memory 152 to the constant speed which is the default (S107), and then ends the job (S108).

On the other hand, in the case where the controller 150 discriminated in S102 that the basis weight is not 52 gsm or less, i.e., is less than 52 gsm, the controller 150 sends an instruction to the offset mechanism 101 (specifically the offset cam driving motor 113) and turns on drive of the offset mechanism 101, so that the offset amount X is changed to +2.5 mm (second offset amount X2) (S109). Thereafter, the controller 150 sends an instruction to the offset mechanism 101 and turns off the drive of the offset mechanism 101 (S110). Further, the controller 150 changes the setting of the registration speed in the memory 152 so that the registration speed is changed from 348.0 mm/s, which is the default corresponding to the process speed which is the constant speed, to 344.5 mm/s (S111). Incidentally, in the case where the controller 150 discriminated in S102 that the basis weight is less than 52 gsm, the controller 150 does not change the setting of the process speed in the memory 152 since the process speed may be kept at the constant speed which is the default. Thereafter, the controller 150 starts the printing operation (S112) and then ends the printing operation after the printing operation of images on a predetermined number of sheets set by the operator (S113). After the end of the printing operation, the controller 150 sends an instruction to the offset mechanism 101 and turns on the drive of the offset mechanism 101 and then changes the offset amount X to −1.3 mm which is the default (S114). Thereafter, the controller 150 sends an instruction to the offset mechanism 101 and turns off the drive of the offset mechanism 101 (S115). Further, the controller 150 returns the setting of the registration speed in the memory 152 to the constant speed which is the default (S116) and then ends the job (S108). Incidentally, in the case where the controller 150 changes the registration speed from the default, the controller 150 corrects the image magnification by the above-described digital registration correction and then causes the image forming apparatus to perform the printing operation.

In the control procedure of FIG. 9, the job for forming the image on the single recording material P was described as an example. In the case where in a continuous image forming job for continuously forming images on a plurality of recording materials P, the kind of the recording material P is changed during the job and there is a need to change the offset amount X, the following may only be required to be performed. That is, in the sheet interval step, the offset amount X is changed and then depending on the changed offset amount X, the registration speed may only be required to be changed.

Here, the offset amount X may only be required to be a desired offset amount X when the recording material P passes through the secondary transfer nip N2 (during the secondary transfer). That is, the change in offset amount X is made so as to be completed before the recording material P on which the image is formed with the changed offset amount X reaches the secondary transfer nip N2. Typically, the change in offset amount X is executed so as to be completed before feeding of the recording material S by the registration roller 13 or feeding of the recording material P from the recording material accommodating portion 11 is started. Further, the registration speed (the feeding speed by the registration roller 13, the recording material P feeding speed) may only be required to be a desired registration speed (a desired feeding speed by the registration roller 13, a desired recording material P feeding speed) when the recording material P passes through the secondary transfer nip N2 (during the secondary transfer). That is, the change in registration speed is made so as to be completed before the recording material P fed at the changed registration speed reaches the secondary transfer nip N2. Typically, the change in registration speed (the change in setting) is executed so as to be completed before the feeding of the recording material P by the registration roller 13 or the feeding of the recording material P from the recording material accommodating portion 11. For example, the drive of the registration roller 13 is started at setting of the changed registration speed.

Further, in this embodiment, the case where the registration speed (the driving speed of the registration roller 13, the feeding speed of the recording material P) when the offset amount X is the first offset amount X1 is the default is described as an example. For that reason, when the offset amount X is the second offset amount X2, the registration speed is reduced from the default. On the other hand, the registration speed when the offset amount X is the second offset amount X2 may also be set at a default. In that case, when the offset amount X is the first offset amount X1, the registration speed is increased from the default.

### 7. Other Viewpoints Relating to Change in Registration Speed

Next, a registration speed changing mode in this embodiment will be described from other viewpoints. As can be understood from progressions of Vbs in FIG. 6, the surface speed of the intermediary transfer belt 21 in the secondary transfer nip N2 has a tendency that by the influence of the curvature of the inner roller 26, the surface speed of the intermediary transfer belt 21 becomes fast correspondingly to the thickness of the intermediary transfer belt 21 at a portion where the intermediary transfer belt 21 is extended and stretched around the inner roller 26. Further, in the case where the offset amount X is different, a state of a grip of the recording material P varies depending on a position of the surface of the intermediary transfer belt 21 continuously changing in recording material P feeding speed. For that reason, there is a tendency that the recording material P feeding speed becomes slower with an increasing offset amount X and becomes faster with a decreasing offset amount X.

It is ideal that in the secondary transfer nip N2, the surface speed of the intermediary transfer belt 21 and the surface speed of the recording material P are made equal to each other. On the other hand, from the viewpoint of feeding efficiency of the recording material P by the intermediary transfer belt 21 and the outer roller 41 in the secondary transfer nip N2, the registration speed is made somewhat faster than the process speed, so that the recording material P is slightly pressed toward the secondary transfer nip N2 by the registration rollers 13 in some instances. That is, this is because it is suppressed that the recording material P passing through the secondary transfer nip N2 is putted by the registration rollers 13 and thus a loop of the recording material P is capable of being formed on a side upstream of the secondary transfer nip N2 with respect to the recording material P feeding direction. When the recording material P passing through the secondary transfer nip N2 is pulled by the registration rollers 13, due to a shock generating when the trailing end portion of the recording material P with respect to the feeding direction passed through the registration rollers 13, the image defect occurs in some instances.

From such viewpoints, as the setting of the registration speed in this embodiment, the following setting is suitable. That is, as shown in part (a) of table 3 appearing hereinafter, in the case where the offset amount X is +2.5 mm, the registration speed is made +0.3% to +0.1% of the process speed. By this, it is possible to suppress that the recording material P passing through the secondary transfer nip N2 is slightly pulled by the registration rollers 13. Here, in the constitution of this embodiment, in the case where the basis weight of the recording material P is relatively small (“thin paper” to “plain paper”), the offset amount X can be made +2.5 mm (see “EMB. 2”). As shown in part (a) of the table 3, for example, in the case of the “thin paper” of less than 150 gsm in basis weight, the registration speed is made about +0.3% of the process speed, and in the case of the “plain paper” of 150 gsm or more in basis weight, the registration speed is made about +0.1% of the process speed. Thus, the reason why in the case where the offset amount X is +2.5 mm, the registration speed when the basis weight of the recording material P is large is made smaller than the registration speed when the basis weight of the recording material P is small is as follows. That is, when the basis weight of the recording material P becomes large, by the influence of the curvature in the secondary transfer nip N2, there is a tendency that the surface speed of the recording material P in the secondary transfer nip N2 becomes fast correspondingly to the thickness of the recording material P, or the like.

On the other hand, as shown in part (b) of the table 3, in the case where the offset amount X is −1.3 mm, the registration speed is made +1.3% of the process speed. By this, even when the recording material P feeding speed in the secondary transfer nip N2 becomes fast due to the small offset amount X as described above, it is possible to suppress that the recording material P passing through the secondary transfer nip N2 is slightly pulled by the registration rollers 13. Here, in the constitution of this embodiment, in the case where the basis weight of the recording material P is relatively large (“thick paper”), the offset amount X can be made −1.3 mm. Further, in the case where the offset amount X is −1.3 mm, the recording material P is not readily bent, so that sensitivity of the registration speed to the

basis weight (thickness) of the recording material P is relatively small. For that reason, even when the basis weight of the recording material P is further increased in the case where the offset amount X is −1.3 mm, the registration speed in the case where the offset amount X is −1.3 mm is not made smaller than the registration speed in the case where the offset amount X is +2.5 mm.

On the other hand, for example, setting of a conventional registration speed in the case where the offset amount X is +2.5 mm was made as shown in part (b) of the table 3 in some instances. That is, in the case of the “thin paper”, as described above, in order to suppress that the recording material P passing through the secondary transfer nip N2 is slightly pulled by the registration rollers 13, the registration speed was made +0.3% of the process speed. Further, in the case of the “thick paper”, resilience of the recording material P is strong and thus the loop thereof is not readily formed, and an upper limit of the registration speed is set for the reason that the recording material P slips in the secondary transfer nip N2 or for the like reason, so that the registration speed was made +0.1% of the process speed.

TABLE 3

| | | |
|---|---|---|
| BASIS | OFFSET | REGISTRATION |
| WEIGHT | (mm) | SPEED |

(a) EMB. 2

| | | |
|---|---|---|
| SMALL*¹ | +2.5 | +0.3% (<150 gsm) |
| | | +0.1% (≥150 gsm) |
| LARGE*² | −1.3 | +1.3% |

(b) CONV. EX.

| | | |
|---|---|---|
| SMALL*¹ | +2.5 | +0.3% |
| LARGE*² | +2.5 | +0.1% |

*¹“SMALL” is thin paper to plain paper.
*²“LARGE” is thick paper.

Thus, in the conventional example, the registration speed was changed depending on the basis weight of the recording material P in some instances. However, in this conventional example (constitution), in the case where the basis weight of the recording material P is relatively large, the registration speed is made smaller than the registration speed in the case where the basis weight of the recording material P is relatively small. On the other hand, according to this embodiment, in the case where the basis weight of the recording material P is relatively large, the offset amount is made smaller than the offset amount in the case where the basis weight of the recording material P is relatively small, so that the registration speed is made relatively large correspondingly. That is, an increase/decrease relationship between the basis weight of the recording material P and the registration speed in the conventional example and an increase/decrease relationship between the basis weight of the recording material P and the registration speed in this embodiment are opposite to each other.

### 8. Effect

In this embodiment, the controller 150 is capable of controlling the feeding (member) driving portion 114 so that the speed ratio Vp/Vb between the driving speed Vb of the intermediary transfer belt 21 by the belt driving portion 112 and the driving speed Vp of the feeding member 13 by the feeding driving portion 114 is a first speed ratio when the transfer is carried out at a first relative position between the inner roller 26 and the outer roller 41 and so that the speed ratio Vp/Vb is a second speed ratio smaller than the first speed ratio when the transfer is carried out at a second relative position between the inner roller 26 and the outer roller 41.

Thus, in this embodiment, in the case where the offset amount X was changed depending on the kind of the recording material P, the registration speed Vp is changed depending on the offset amount X, so that the feeding speed ratio Vp/Vb is changed. By this, a fluctuation in surface speed ratio Vps/Vbs in the secondary transfer nip N2 is suppressed, so that the occurrence of the “image abrasion” can be suppressed. Accordingly, according to this embodiment, it is possible to not only improve a transfer property of the image onto each of the plurality of recording materials P by changing the offset amount X but also suppress the occurrence of the image defect in the secondary transfer nip N2 due to the change in offset amount X.

Incidentally, in this embodiment, the case where the process speed is switched between the constant speed and the half speed depending on the basis weight of the recording material P was described, but the change in process speed is not limited to that made depending on the basis weight of the recording material P. Accordingly, for example, in the case where the process speed is switched to the half speed without being based on the basis weight of the recording material P, the offset amount X is changed depending on the basis weight of the recording material P and then the registration speed Vp is changed depending on the changed offset amount X, so that the feeding speed ratio Vp/Vb may also be changed. That is, for the plurality of process speeds, a plurality of offset amounts X and a plurality of feeding speed ratios Vp/Vb corresponding to the offset amounts X, respectively, may also be set, respectively.

Further, the feeding speed ratio Vp/Vb represents an index indicating a difference between the feeding speed Vb of the intermediary transfer belt 21 and the feeding speed Vp of the recording material P, so that the present invention is not limited to the case of using the feeding speed ratio Vp/Vb itself as a target control value. For example, the case where a difference itself between the feeding speed Vb of the intermediary transfer belt 21 and the feeding speed Vp of the recording material P is used as the target control value or the like, with the result that the feeding speed ratio Vp/Vb is changed or the like case is included in the case where the feeding speed ratio Vp/Vb is changed.

### Embodiment 2

Next, another embodiment of the present invention will be described. Basic constitutions and operations of an image forming apparatus in this embodiment are the same as those of the image forming apparatus in the embodiment 1. Accordingly, elements having the same or corresponding functions or constitutions as those in the embodiment 1 are represented by the same reference numerals or symbols as those in the embodiment 1 and will be omitted from detailed description.

1. Outline of this Embodiment

In the embodiment 1, the offset amount X was changed depending on the basis weight of the recording material P, and on the basis of the changed offset amount X, the registration speed Vp was changed, so that the feeding speed ratio Vp/Vb was changed.

On the other hand, in this embodiment, in the case where an image can be formed on a predetermined recording material P with a predetermined basis weight at each of settings of a plurality of offset amounts X, the feeding speed ratio Vp/Vb is changed by changing the registration speed Vp depending on the offset amount X. Examples of the case where the image can be formed on the recording material P with the same basis weight include the following cases.

In the image forming apparatus using an electrophotographic type or the like, for example, in order to perform bookbinding printing, a continuous image forming job for forming images on a plurality of kinds of recording materials P (this job is also referred to as a “mixed job” in this embodiment) is executed in some instances. For example, the case where the recording material P is changed between “thin paper” (for example, 48 gsm in basis weight) and “plain paper” (for example, 81 gsm in basis weight) and the like case exist. In the case here such a mixed job is executed, when the offset amount X is changed by using a predetermined threshold (52 gsm in the embodiment 1) as described in the embodiment 1, the offset amount X is frequently changed during the job in some instances. When an operation of changing the offset amount X is changed is performed, the image formation cannot be carried out. Further, in the case where the offset amount X is changed during the job, before the inner roller 26 is moved, there is a need to a stop of application of high voltages for an image forming system, such as the charging voltage, the developing voltage, the primary transfer voltage and the secondary transfer voltage in some instances. Further, there is a need to stop rotation of the intermediary transfer belt 21 and to separate the outer roller 41 from the intermediary transfer belt 21 in some instances. For that reason, when the change in offset amount X is excessively made frequently, there is a liability that productivity lowers. Further, when the change in offset amount X is excessively made frequency, there is a liability that abrasion and deterioration of the intermediary transfer belt 21, the inner roller 26 or the outer roller 41 are accelerated.

Here, in the embodiment 1, the above-described predetermined threshold (=52 gsm) was used, and the second offset amount X2 (=+2.5 mm) was used when the basis weight of the recording material P was less than the threshold and the first offset amount X1 (=−1.3 mm) was used when the basis weight of the recording material P was the threshold or more. However, even in either case of the first offset amount X1 (=−1.3 mm) and the second offset amount X2 (=+2.5 mm), there is a case that a basis weight region such that improper separation of the recording material P from the intermediary transfer belt 21 and an image defect at a trailing end portion of the recording material P with respect to the recording material feeding direction (this image defect is also simply referred to as a “trailing end portion image defect”) do not occur exists in some instances. For example, in the constitution of this embodiment, in the case of the recording material with the basis weight of 52 gsm or more and less than 300 gsm, in either of the first offset amount X1 and the second image abrasion X2, the improper separation and the trailing end portion image defect do not occur. Specifically, in the case of the recording material P with the basis weight of 52 gsm or more and less than 300 gsm, when the offset amount X is the second offset amount X2 (=+2.5 mm), the trailing end portion image defect occurs in some rare cases. For that reason, when priority is given to an image quality, in the case of the recording material P with the basis weight of 52 gsm or more and less than 300 gsm, the offset amount X may preferably be the first offset amount X1 (=−1.3 mm). However, when priority is given to productivity (speed), in the case of the recording material P with the basis weight of 52 gsm or more and less than 300 gsm, the offset amount X may be either of the first offset amount (=−1.3 mm) and the second offset amount X2 (=+2.5 mm).

Therefore, in this embodiment, the image forming apparatus 100 is constituted so as to be capable of executing the job in an “image quality priority mode (or normal mode)” as a first mode and in a “speed priority mode (or productivity priority mode)” as a second mode. In the case where the “image quality priority mode” is ON (in the case where the speed priority mode is OFF), a first threshold (=52 gsm) is used as a threshold of the recording material P basis weight for changing the offset amount X. Further, in the case of the recording material P with the basis weight which is less than the first threshold, the offset amount X is the second offset amount X2 (=+2.5 mm), and in the case of the recording material P with the basis weight which is the first threshold or more, the offset amount X is the first offset amount X1 (=−1.3 mm). On the other hand, in the case where the “speed priority mode” is ON, a second threshold (=300 gsm) larger than the first threshold (=52 gsm) is used as the threshold of the recording material P basis weight for changing the offset amount X. Further, in the case of the recording material P with the basis weight of less than the second threshold, the offset amount X is the second offset amount X2 (=+2.5 mm), and in the case of the recording material P with the basis weight which is the second threshold or more, the offset amount X is the first offset amount X1 (=−1.3 mm). Incidentally, in this embodiment, similarly as in the embodiment 1, in the case of the recording material P with the basis weight which is the second threshold (=300 gsm) or more, the process speed is made of the half speed. By this, in the case where the “speed priority mode” is ON, for a user who principally uses, for example, the “thin paper” or the “plain paper”, a frequency of the change in offset amount X is reduced, so that the productivity can be improved. That is, in the “speed priority mode”, in the case where a use frequency of the “thin paper” or the “plain paper” is higher than a user frequency of the “thick paper”, compared with the “image quality priority mode”, the frequency of the change in offset amount X is reduced, so that the productivity can be improved.

Further, in this embodiment, in the case where the images can be formed on the predetermined recording materials P (for example, the plain paper with the basis weight of 81 gsm) which is the predetermined basis weight, in the cases of the first and second offset amounts X1 and X2, the feeding speed ratio Vp/Vb is changed by changing the registration speed Vp depending on the offset amount X.

A table 4 below shows an example of settings of the process speed, the offset amount and the registration speed which are preset, as a printing operation condition in this embodiment, depending on the basis weight of the recording material P. Pieces of information of the printing operation condition as shown in the table 4 are stored in the memory 152 in advance.

TABLE 4

| BASIS | PROCESS | OFFSET | REGISTRATION | |
|---|---|---|---|---|
| WEIGHT | SPEED | AMOUNT | SPEED | |
| M | Vb | X | Vp | |
| (gsm) | (mm/s) | (mm) | (mm/s) | Vp/Vb |
| 48 | 345.9 | +2.5 | 344.5 | 0.996 |
| (SP/IQ PM)*¹ | (CS)*⁴ | | | |
| 81 | 345.9 | +2.5 | 344.5 | 0.996 |
| (SP PM)*² | (CS)*⁴ | | | |
| 81 | 345.9 | −1.3 | 348.0 | 1.006 |
| (IQ PM)*³ | (CS)*⁴ | | | |
| 350 | 172.9 | −1.3 | 174.0 | 1.006 |
| (SP/IQ PM)*¹ | (HS)*⁵ | | | |

*¹“SP/IQ PM” is the speed/image quality priority mode.
*²“SP PM” is the speed priority mode.
*³“IQ PM” is the image quality priority mode.
*⁴“CS” is the constant speed.
*⁵“HS” is the half speed.

### 2. Control Procedure

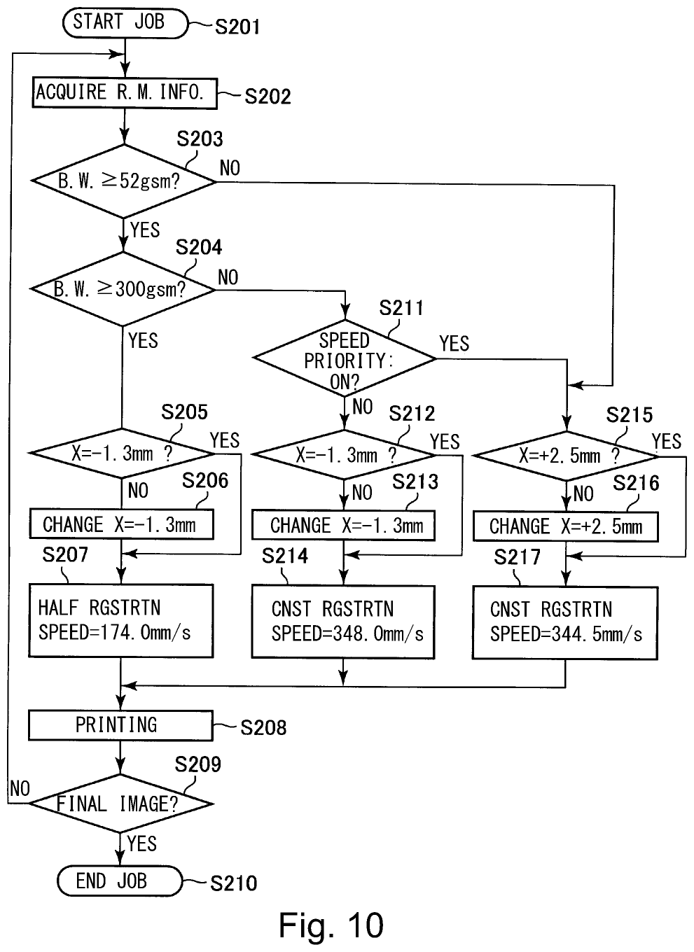

FIG. 10 is a flowchart showing an outline of an example of a control procedure of a job in this embodiment. In this embodiment, the case where an operator causes the image forming apparatus 100 to execute a continuous image forming job through the operating portion 160 of the apparatus main assembly 110 will be described as an example. Further, in FIG. 10, the outline of the control procedure in which attention is given to an operation of changing the offset amount and the registration speed is shown, and other many operations necessary in general to output the images by executing the job are omitted.

When the controller 150 acquires information on the job depending on the operation by the operator such as a user at the operating portion 160, the controller 150 sends instructions to respective portions of the image forming apparatus 100 and causes the image forming apparatus 100 to start the job. When the controller 150 acquires information on the recording material P basis weight included in the job information (S202), the controller 150 discriminates whether or not the basis weight of the recording material P is 52 gsm (first threshold) or more (S203). In the case where the controller 150 discriminated in S203 that the basis weight is 52 gsm or more, the controller 150 discriminates whether or not the basis weight is 300 gsm (second threshold) or more (S204). In the case where the controller 150 discriminated in S204 that the basis weight is 300 gsm or more, the controller 150 discriminates whether or not a current offset amount X is −1.3 mm (first offset amount X1) on the basis of an output value of the offset cam position sensor 37 (S205). Then, in the case where the controller 150 discriminated in S205 that the current offset amount X is not −1.3 mm, the controller 150 sends an instruction to the offset mechanism 101 and causes the offset mechanism 101 to change the offset amount X to −1.3 mm (S206). Then, the controller 150 sets (setting of) the process speed in the memory 152 at the half speed and sets (setting of) the registration speed in the memory 152 at 174.0 mm/s which is the default for the process speed (half speed) (S207). Then, the controller 150 sends instructions to the respective portions of the image forming apparatus 100 and causes the image forming apparatus 100 to execute a printing operation with the changed offset amount X as needed and at the process speed and the registration speed which are set (S208).

Thereafter, the controller 150 discriminates whether or not the currently formed image is a final image of the job (S209). In the case where the controller 150 discriminated in S209 that the image is the final image, the controller 150 sends instructions to the respective portions of the image forming apparatus 100 and causes the image forming apparatus 100 to end the operation of the job (S210). Further, in the case where the controller 150 discriminated in S209 that the image is not the final image, the procedure returns to the process of S202.

In the case where the controller 150 discriminated in S204 that the basis weight is not 300 gsm or more (the basis weight is 52 gsm or more and less than 300 gsm), the controller 150 acquires information on mode setting in the memory 152 and discriminated whether or not the “speed priority mode” is ON (enabled) (S211). Incidentally, in this embodiment, setting of ON (enabled) and OFF (disabled) of the “speed priority mode” can be made through a mode setting screen displayed on the touch panel or the like of the operating portion 160. For example, this screen is provided with a button for setting the “speed priority mode” at ON and a button for setting the “speed priority mode” at OFF, and information on setting of ON/OFF of the “speed priority mode” is stored in the memory 152 by selecting (pressing down) either one of the buttons by the operator. Also, as regards the “image quality priority mode”, setting may also be capable of being made similarly as described above, but in the case where the “speed priority mode” is OFF, the “image quality priority mode” may also be made ON.

In the case where the controller 150 discriminated in S211 that the “speed priority mode” is not ON (i.e., the “image quality priority mode” is ON), the controller 150 discriminates whether or not the current offset amount X is −1.3 mm (first offset amount X1) on the basis of an output value of the offset cam position sensor 37 (S212). Then, in the case where the controller 150 discriminated in S212 that the current offset amount X is not −1.3 mm, the controller 150 sends an instruction to the offset mechanism 101 and causes the offset mechanism 101 to change the offset amount X to −1.3 mm (S213).

Further, the controller 150 sets the process speed in the memory 152 at the constant speed and sets the registration speed in the memory 152 at 348.0 mm which is the default for the process speed (constant speed) (S214). Then, the controller 150 sends instructions to the respective portions of the image forming apparatus 100 and causes the image forming apparatus 100 to execute the printing operation with the changed offset amount X as desired and at the process speed and the registration speed which are set (S208). The control procedure in S209 and later is as described above.

Further, in the case where the controller 150 discriminated in S211 that the “speed priority mode” is ON, the controller 150 discriminates whether or not the current offset amount X is +2.5 mm (second offset amount X2) on the basis of an output value of the offset cam position sensor 37 (S215). Then, in the case where the controller 150 discriminated in S215 that the current offset amount X is not +2.5 mm, the controller 150 sends an instruction to the offset mechanism 101 and causes the offset mechanism 101 to change the offset amount X to +2.5 mm (S216). Further, the controller 150 sets the process speed in the memory 152 at the constant speed and sets the registration speed in the memory 152 at 344.5 mm which is decreased from the default for the process speed (constant speed) (S217). Then, the controller 150 sends instructions to the respective portions of the image forming apparatus 100 and causes the image forming apparatus 100 to execute the printing operation with the changed offset amount X as desired and at the process speed and the registration speed which are set (S208). The control procedure in S209 and later is as described above.

Further, in the case where the controller 150 discriminated in S203 that the basis weight is not 52 gsm (i.e., the basis weight is less than 52 gsm), the procedure goes to the process of S215, and the controller 150 performs subsequent processes in the above-described manner.

### 3. Effect

As described above, in this embodiment, in the case where the images can be formed on the recording materials P having substantially the same basis weight with the different offset amounts X, the feeding speed ratio Vp/Vb is changed by changing the registration speed Vp depending on the offset amount X. By this, a fluctuation in surface speed ratio Vps/Vbs in the secondary transfer nip N2 is suppressed, so that the occurrence of the “image abrasion” can be suppressed. Accordingly, according to this embodiment, it is possible to suppress the occurrence of the image defect in the secondary transfer nip N2 due to the change in offset amount.

### Embodiment 3

Next, another embodiment of the present invention will be described. Basic constitutions and operations of an image forming apparatus in this embodiment are the same as those of the image forming apparatus in the embodiment 1. Accordingly, elements having the same or corresponding functions or constitutions as those in the embodiment 1 are represented by the same reference numerals or symbols as those in the embodiment 1 and will be omitted from detailed description.

1. Outline of this Embodiment

In the embodiment 1, the outer roller 41 was rotated with rotation of the intermediary transfer belt 21. Further, in the embodiment 1, the feeding speed of the recording material P in the secondary transfer nip N2 was controlled by changing the feeding speed of the recording material P by the registration rollers 13 (the driving speed (the number of rotations) of the registration rollers 13 by the registration driving portion 114).

On the other hand, in this embodiment, the outer roller 41 is driven and rotated. Further, in this embodiment, the feeding speed of the recording material P in the secondary transfer nip N2 is controlled by changing the driving speed 8 the number of rotations) of the outer roller 41 by the outer roller driving portion 115 described later.

### 2. Control Mode

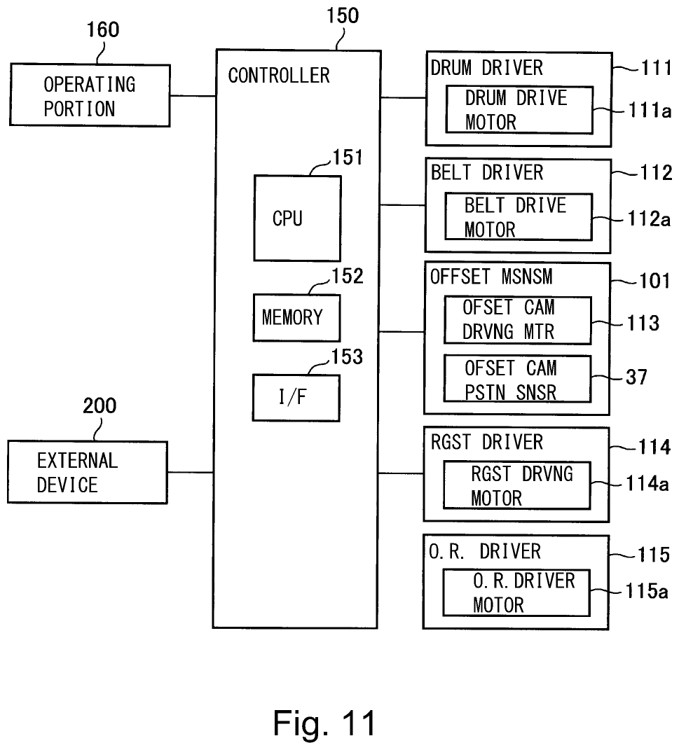

FIG. 11 is a block diagram showing a control mode of a principal part of the image forming apparatus 100 of this embodiment. The control mode of this embodiment shown in FIG. 11 is similar to the control mode of the embodiment 1 shown in FIG. 8, but in this embodiment, to the controller 150, the outer roller driving portion 115 as a driving means including the outer roller driving motor 115a as a driving source is connected.

In this embodiment, the outer roller 41 obtains a driving torque by the outer roller driving portion 115. Further, in this embodiment, the number of rotations of the outer roller driving motor 115a of the outer roller driving portion 115 is controlled by the controller 150, and thus the number of rotations of the outer roller 41 is controlled, so that the feeding speed of the recording material P in the secondary transfer nip N2 can be changed.

As described in the embodiment 1, the feeding speed Vp of the recording material P is a moving speed of a surface (back surface) of the recording material P on a side where the recording material P contacts the outer roller 41. Further, in this embodiment, the feeding speed Vp of the recording material P can be specifically represented by a driving speed of the outer roller 41 by the outer roller driving portion 115, more specifically represented by a peripheral speed (rotational speed, the number of rotations per unit time of the outer roller 41. Herein, the feeding speed (the driving speed of the outer roller 41) Vp of the recording material P is also referred to as an “outer roller speed”.

In this embodiment, the outer roller speed Vp is set every process speed so that a value thereof when the offset amount X is the first offset amount X1 corresponding to the home position of the inner roller 26 is a default (value). Further, in this embodiment, the process speed Vb is set at a constant speed as the default.

In this embodiment, similarly as in the embodiment 1, the image forming apparatus 100 changes ratio (feeding speed ratio) Vp/Vb between the feeding speed Vp of the intermediary transfer belt 21 and the feeding speed Vp of the recording material P depending on the offset amount X. As described in the embodiment 1, the feeding speed Vb of the intermediary transfer belt 21 can be represented by the driving speed of the intermediary transfer belt 21 by the belt driving portion 112. Further, as described above, in this embodiment, the feeding speed of the recording material P can be represented by the driving speed of the outer roller 41 by the outer roller driving portion 115. For that reason, in this embodiment, the above-described feeding speed ratio can be called a ratio (driving speed ratio) Vp/Vb between the driving speed Vp of the intermediary transfer belt 21 by the belt driving portion 112 and the driving speed Vp of the outer roller 41 by the outer roller driving portion 115. In this embodiment, instead of the change in registration speed in the embodiment 1, the outer roller speed is changed, so that the feeding speed ratio Vp/Vb can be changed similarly as in the embodiment 1. By this, a fluctuation in surface speed ratio Vps/Vbs in the secondary transfer nip N2 by the change in offset amounts X (X1, X2) is made small, so that the “image abrasion” is suppressed.

Incidentally, in the case where the outer roller speed is changed from the default, a magnification fluctuation of the image with respect to the recording material feeding direction occurs during the secondary transfer. For that reason, similarly as in the embodiment 1, the controller 150 can make correction (digital registration correction) so as to suppress the magnification fluctuation by correcting information, of digital image information (image data) sent to the image forming apparatus 100, on a magnification of the image with respect to the recording material feeding direction.

A table 5 shows an example of settings of the process speed, the offset amount and the outer roller speed which are preset depending on the basis weight of the recording material P as the printing operation condition in this embodiment. Pieces of information on the printing operation condition as shown in the table 5 are stored in advance in the memories 152.

TABLE 5

| BW*¹ | PS*² | OA*³ | ORS*⁴ | |
|---|---|---|---|---|
| M | Vb | X | Vp | |
| (gsm) | (mm/s) | (mm) | (mm/s) | Vp/Vb |
| 48 | 345.9 (CS*⁵) | +2.5 | 344.5 | 0.996 |
| 81 | 345.9 (CS*⁵) | −1.3 | 348.0 | 1.006 |
| 350 | 172.9 (HS*⁶) | −1.3 | 174.0 | 1.006 |

*¹“BW” is the basis weight.
*²“PS” is the process speed.
*³“OA” is the offset amount.
*⁴“RS” is the registration speed.
*⁵“CS” is the constant speed.
*⁶“HS” is the half speed.

### 3. Control Procedure

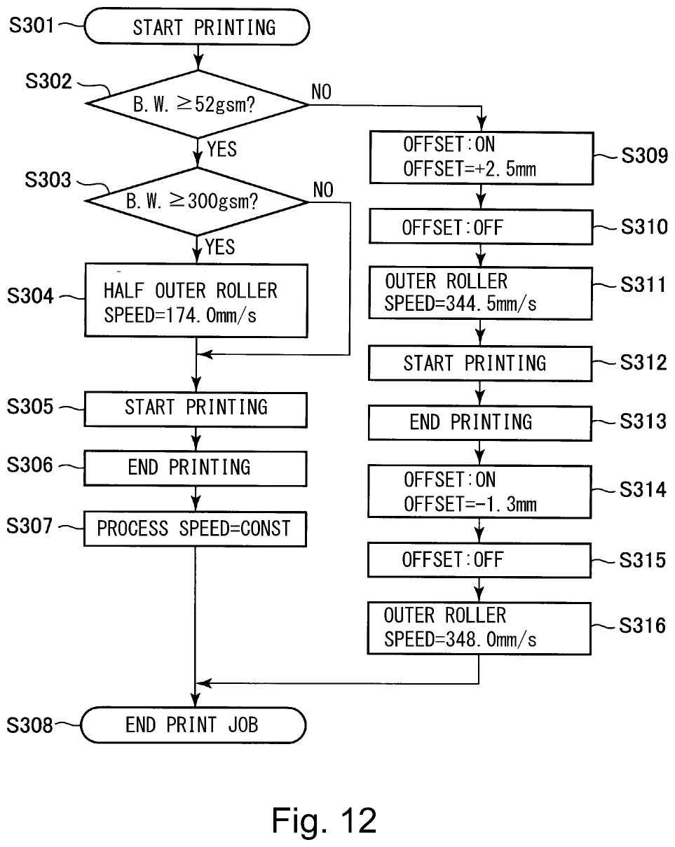

FIG. 12 is a flowchart showing an outline of an example of a control procedure of a job in this embodiment. Processes of S301 to S316 in the control procedure of FIG. 12 are similar to the processes of S101 to S116, respectively, in the control procedure of FIG. 9. However, in this embodiment, in S304, the controller 150 changes the setting of the outer roller speed in the memory 152 so that the outer roller speed is changed to 174.0 mm/s which is the default for the process speed (half speed).

Further, in this embodiment, in S311, the controller 150 changes the setting of the outer roller speed in the memory 152 so that the outer roller speed is changed from 348.0 mm/s, which is the default corresponding to the process speed which is the constant speed, to 344.5 mm/s. Further, In this embodiment, in S316, the controller 150 returns the setting of the outer roller speed in the memory 152 to the constant speed which is the default.

In the control procedure of FIG. 12, the job for forming the image on the single recording material P was described as an example. In the case where in a continuous image forming job for continuously forming images on a plurality of recording materials P, the kind of the recording material P is changed during the job and there is a need to change the offset amount X, the following may only be required to be performed. That is, in the sheet interval step, the offset amount X is changed and then depending on the changed offset amount X, the outer roller speed may only be required to be changed.

Here, the outer roller speed (the feeding speed by the outer roller 41, the recording material P feeding speed) may only be required to be a desired outer roller speed (a desired feeding speed by the outer roller 41, a desired recording material P feeding speed) when the recording material P passes through the secondary transfer nip N2 (during the secondary transfer). That is, the change in outer roller speed is made so as to be completed before the recording material P fed at the changed outer roller speed reaches the secondary transfer nip N2. Typically, the change in outer roller speed (the change in setting) is executed so as to be completed before the feeding of the recording material P by the outer roller 41, the feeding of the recording material P by the registration roller 13, or the feeding of the recording material P from the recording material accommodating portion 11. For example, the drive of the outer roller 41 is started at setting of the changed outer roller speed.

Further, in this embodiment, the case where the outer roller speed (the driving speed of the outer roller 41, the feeding speed of the recording material P) when the offset amount X is the first offset amount X1 is the default is described as an example. For that reason, when the offset amount X is the second offset amount X2, the outer roller speed is decreased from the default. On the other hand, the outer roller speed in the case where the offset amount X is the second offset amount X2 may also be used as the default. In that case, when the offset amount X is the first offset amount X1, the outer roller speed is increased from the default.

Incidentally, in this embodiment, the change in outer roller speed was made with the change in offset amount X, but the change in registration speed may also be made with the change in offset amount X. That is, the control similar to the control in the embodiment 1 may also be carried out in combination.

### 4. Effect

In this embodiment, the controller 150 is capable of controlling the outer roller driving portion 114 so that the speed ratio Vp/Vb between the driving speed Vb of the intermediary transfer belt 21 by the belt driving portion 112 and the driving speed Vp of the outer roller 41 by the outer roller driving portion 114 is a first speed ratio when the transfer is carried out at a first relative position between the inner roller 26 and the outer roller 41 and so that the speed ratio Vp/Vb is a second speed ratio smaller than the first speed ratio when the transfer is carried out at a second relative position between the inner roller 26 and the outer roller 41.

Thus, the feeding speed ratio Vp/Vb is changed by changing the outer roller speed Vp depending on the offset amount S. Also, by this, a fluctuation in surface speed ratio Vps/Vbs in the secondary transfer nip N2 is suppressed, so that the occurrence of the “image abrasion” can be suppressed. Accordingly, according to this embodiment, it is possible to not only improve a transfer property of the image onto each of the plurality of recording materials P by changing the offset amount X but also suppress the occurrence of the image defect in the secondary transfer nip N2 due to the change in offset amount X.

### Embodiment 4

Next, another embodiment of the present invention will be described. Basic constitutions and operations of an image forming apparatus in this embodiment are the same as those of the image forming apparatus in the embodiment 1. Accordingly, elements having the same or corresponding functions or constitutions as those in the embodiment 1 are represented by the same reference numerals or symbols as those in the embodiment 1 and will be omitted from detailed description.

In the embodiment 3, the offset amount X was changed depending on the basis weight of the recording material P, and on the basis of the changed offset amount X, the outer roller speed Vp was changed, so that the feeding speed ratio Vp/Vb was changed.

On the other hand, in this embodiment, in the case where an image can be formed on a predetermined recording material P with a predetermined basis weight at each of settings of a plurality of offset amounts X, the feeding speed ratio Vp/Vb is changed by changing the outer roller speed Vp depending on the offset amount X.

In this embodiment, the control procedure is similar to the control procedure in the embodiment 2 except that the outer roller speed is changed instead of the change in registration speed in the embodiment 2. Accordingly, in this embodiment, description of the embodiment 2 is quoted by reading the registration speed as the outer roller speed and redundant description will be omitted.

A table 6 below shows an example of settings of the process speed, the offset amount and the outer roller speed which are preset, as a printing operation condition in this embodiment, depending on the basis weight of the recording material P. Pieces of information of the printing operation condition as shown in the table 6 are stored in the memory 152 in advance.

TABLE 6

| | | | OUTER | |
|---|---|---|---|---|
| BASIS | PROCESS | OFFSET | ROLLER | |
| WEIGHT | SPEED | AMOUNT | SPEED | |
| M | Vb | X | Vp | |
| (gsm) | (mm/s) | (mm) | (mm/s) | Vp/Vb |
| 48 | 345.9 | +2.5 | 344.5 | 0.996 |
| (SP/IQ PM)*¹ | (CS)*⁴ | | | |
| 81 | 345.9 | +2.5 | 344.5 | 0.996 |
| (SP PM)*² | (CS)*⁴ | | | |
| 81 | 345.9 | −1.3 | 348.0 | 1.006 |
| (IQ PM)*³ | (CS)*⁴ | | | |
| 350 | 172.9 | −1.3 | 174.0 | 1.006 |
| (SP/IQ PM)*¹ | (HS)*⁵ | | | |

*¹“SP/IQ PM” is the speed/image quality priority mode.
*²“SP PM” is the speed priority mode.
*³“IQ PM” is the image quality priority mode.
*⁴“CS” is the constant speed.
*⁵“HS” is the half speed.

As described above, in this embodiment, a constitution in which the feeding speed ratio Vp/Vb is changed by changing the outer roller speed in the image forming apparatus 100 is employed. In in this embodiment, in the constitution, in the case where the images can be formed on the recording materials P having substantially the same basis weight with the different offset amounts X, the feeding speed ratio Vp/Vb is changed by changing the outer roller speed Vp depending on the offset amount X. By this, a fluctuation in surface speed ratio Vps/Vbs in the secondary transfer nip N2 is suppressed, so that the occurrence of the “image abrasion” can be suppressed. Accordingly, according to this embodiment, it is possible to suppress the occurrence of the image defect in the secondary transfer nip N2 due to the change in offset amount.

### OTHER EMBODIMENTS

The present invention was described above based on specific embodiments, but is not limited thereto.

In the above-described embodiments, the constitution in which, the offset amount is changed by changing the position of the inner roller is employed, but a constitution in which the offset amount J changed by changing the position of the outer roller may also be employed. Further, the present invention is not limited to a constitution in which either one of the inner roller and the outer roller is moved but may also employ a constitution in which the offset amount is changed by moving both the inner roller and the outer roller.

In the above-described embodiments, as an outer member for forming the secondary transfer nip in cooperation with the inner roller as an inner member, the outer roller directly contacting the outer peripheral surface of the intermediary transfer belt was used. On the other hand, a constitution in which as the outer member, the outer roller and a secondary transfer belt stretched by the outer roller and other rollers are used may also be employed. That is, the image forming apparatus may include, as the outer member, the stretching rollers, the outer roller and the secondary transfer belt stretched between these rollers. Further, the secondary transfer roller is contacted to the outer peripheral surface of the intermediary transfer belt by the outer roller. In such a constitution, by the inner roller contacting the inner peripheral surface of the intermediary transfer belt and the outer roller contacting the inner peripheral surface of the secondary transfer belt, the intermediary transfer belt and the secondary transfer belt are sandwiched, so that the secondary transfer nip is formed. In this case, a contact portion between the intermediary transfer belt and the secondary transfer belt is the secondary transfer nip as the secondary transfer portion. Incidentally, also in this case, the offset amount X is defined by the relative position between the inner roller and the outer roller similarly as described above.

In the above-described embodiment, the offset amount was described by two patterns, but three or more patterns may also be set. In this case, for example, Vp/Vb may only be required to be different at least between a largest basis weight and a smallest basis weight, and a pattern in which Vp/Vb is the same may also be used.

In the above-described embodiments, as the information on the kind of the recording material relating to the rigidity of the recording material was used, but the present invention is not limited thereto. In the case where a paper kind category (for example, plain paper and coated paper which are the paper kind categories based on a surface property) or a brand (including a manufacturer, a product number or the like) is the same, the basis weight of the recording material and the thickness of the recording material are in a substantially proportional relationship in many instances (in which the basis weight is larger with an increasing thickness). Further, in the case where the paper kind category or the brand is the same, the present invention of the recording material, and the basis weight or the thickness of the recording material are in a substantially proportional relationship in many instances (in which the rigidity is larger with an increasing basis weight or thickness). Accordingly, for example, the offset amount can be set on the basis of the basis weight, the thickness or the rigidity of the recording material for each of the paper kind categories, the brands or combinations of the paper kind category and the brand. Further, the controller is capable of causing the offset mechanism to operate so as to provide the offset amount depending on the recording material, on the basis of information on the paper kind category, the brand and the like which are inputted from the operating portion and the external device and on the basis of the basis weight, the thickness, the rigidity and the like of the recording material. Further, the present invention is not limited to use of, as the information on the kind of the recording material, quantitative information on, for example, the basis weight, the thickness or the rigidity. As the information on the kind of the recording material, for example, only qualitative information on the paper kind category, the brand or a combination of the paper kind category and the brand can be used. For example, the offset amount is set depending on the paper kind category, the brand or a combination of the paper kind category and the brand, and then the controller is capable of determining the offset amount depending on the information on the paper kind category, the brand and the like which are inputted from the operating portion, the external device or the like. Also, in this case, the offset amount is assigned on the basis of a difference in rigidity between the recording materials. Incidentally, the rigidity of the recording material can be represented by Gurley rigidity (stiffness) (MD/long fold) [mN] and can be measured by a commercially available Gurley stiffness tester. For example, the Gurley stiffness (MD) which is an example of the rigidity of the “thin paper” as the recording material of less than 52 gsm (g/m²) which is the threshold of the basis weight in the above-described embodiments is about 0.3 mN in some instances. Further, the Gurley stiffness (MD) which is the example of the rigidity of the “plain paper” (basis weight: about 80 g/m²) as the recording material of not less than 52 gsm (g/m²) which is the threshold of the basis weight in the above-described embodiments is about 2 mN, and the Gurley stiffness (MD) which is the example of the rigidity of the “thick paper” (basis weight: about 200 g/m²) is about 20 mN in some instances.

In the above-described embodiments, description of the controller was made that the controller acquires the information in the kind of the recording material on the basis of the input thereof from the operating portion or the external device through the operation by the operator, but the controller may also acquire the information on the kind of the recording material on the basis of the input of a detection result of the detecting means. For example, a basis weight sensor can be used as a basis weight detecting means for detecting an index value correlating with the basis weight of the recording material. As the basis weight sensor, for example, a basis weight sensor utilizing attenuation of ultrasonic wave has been known. This basis weight sensor includes an ultrasonic generating portion and an ultrasonic receiving portion which are provided so as to sandwich a recording material feeding passage. The basis weight sensor generates the ultrasonic wave from the ultrasonic generating portion and receives the ultrasonic wave attenuation by being passed through the recording material, and then on the basis of attenuation amount of the ultrasonic wave, detects the index value correlating with the basis weight of the recording material. Incidentally, the basis weight detecting means may only be required to be capable of detecting the index value correlating with the basis weight of the recording material and is not limited to the basis weight detecting means utilizing the ultrasonic wave, but may also be a basis weight detecting means utilizing light, for example. The index value correlating the basis weight of the recording material is not limited to the basis weight itself, but may also be a thickness corresponding to the basis weight. Further, a surface property sensor can be used as a smoothness detecting means for detecting an index value correlating with surface smoothness of the recording material capable of being utilized for detecting the paper kind category. As the surface property sensor, a regularly/irregularly reflected light sensor for reading intensity of regularly reflected light and irregularly reflected light by irradiating the recording material with light has been known. In the case where the surface of the recording material is smooth, the regularly reflected light becomes strong, and in the case where the surface of the recording material is rough, the irregularly reflected light becomes strong. For that reason, the surface property sensor is capable of detecting the index value corresponding with the smoothness of the recording material surface by measuring a regularly reflected light quantity and an irregularly reflected light quantity. Incidentally, the smoothness detecting means may only be required to be capable of detecting the index value correlating with the smoothness of the recording material surface and is not limited to the above-described smoothness detecting means using the light quantity sensor, but may also be a smoothness detecting means using, for example, an image-pick up element. The index correlating the smoothness of the recording material surface is not limited to a value converted to a value in conformity to a predetermined standard such as Bekk smoothness, but may only be required to be a value having a correlation with the smoothness of the recording material surface. These detecting means can be disposed adjacent to the recording material feeding passage on a side upstream of the recording material rollers with respect to the recording material feeding direction, for example. Further, for example, a detecting means (media sensor) constituted as a single voltage including the above-described basis weight sensor, the surface property sensor, and the like.

In the above-described embodiments, as the small, an actuator for actuating the movable portion by the cam was used, but the offset mechanism is not limited thereto. The offset mechanism may only be required to be capable of realizing an operation in conformity to each of the above-described embodiments, and for example, an actuator for actuating the movable portion by using a solenoid, for example.

Further, in the above-described embodiments, the case where the belt-shaped image bearing member was the intermediary transfer belt was described, but the present invention is applicable when an image bearing member constituted by an endless belt for feeding the toner image borne at the image forming position is used. Examples of such a belt-shaped image bearing member may include a photosensitive (member) belt and an electrostatic recording dielectric (member) belt, in addition to the intermediary transfer belt in the above-described embodiments.

Further, the present invention can be carried out also in other embodiments in which a part or all of the constitutions of the above-described embodiments are replaced with alternative constitutions thereof. Accordingly, when the image forming apparatus using the belt-shaped image bearing member is used, the present invention can be carried out with no distinction as to tandem type/single drum type, a charging type, an electrostatic image forming type, a developing type, a transfer type and a fixing type. In the above-described embodiments, a principal part relating to the toner image formation/transfer was described principally, but the present invention can be carried out in various uses, such as printers, various printing machines, copying machines, facsimile machines and multi-function machines, by adding necessary device, equipment and a casing structure.

According to the present invention, the occurrence of the image defect in the transfer portion due to the change in offset amount can be suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-031083 filed on Feb. 26, 2020, which is hereby incorporated by reference herein in its entirety.

What is claimed is:

1. An image forming apparatus comprising:
an image forming portion configured to form a toner image;
a rotatable intermediary transfer belt onto which the toner image formed by said image forming portion is transferred;
a plurality of stretching rollers stretching said intermediary transfer belt and including an inner roller and an upstream roller provided adjacent to said inner roller on a side upstream of said inner roller with respect to a rotational direction of said intermediary transfer belt;
an outer roller contacting an outer peripheral surface of said intermediary transfer belt and configured to form a transfer nip, where the toner image is transferred from said intermediary transfer belt onto a recording material, by nipping said intermediary transfer belt between itself and said inner roller;
a moving mechanism capable of moving a position of said inner roller between a first position where an offset amount X is a first offset amount X1 and a second position where the offset amount X is a second offset amount X2 which is larger than the first offset amount X1 and which is larger than zero, wherein in a cross section perpendicular to a rotational axis direction of said inner roller, an external common tangential line between said inner roller and said upstream roller on a side where said intermediary transfer belt is stretched by these rollers is a reference line L1, a rectilinear line passing through a rotation center of said inner roller and perpendicular to the reference line L1 is an inner roller center line L2, a rectilinear line passing through a rotation center of said outer roller and perpendicular to the reference line L1 is an outer roller center line L3, and a distance between the inner roller center line L2 and the outer roller center line L3 is the offset amount X which is a positive value when the outer roller center line L3 is positioned upstream of the inner roller central line L2 with respect to the rotational direction of said intermediary transfer belt;
a feeding member configured to feed the recording material to the transfer nip;
a driving source configured to drive said feeding member; and
a controller configured to control said driving source,
wherein said controller controls said driving source so that
when an image is formed in a state in which said inner roller is in the first position, a speed ratio Vp/Vb wherein Vp is a driving speed of said feeding member and Vb is a driving speed of said intermediary transfer belt is a first speed ratio, and
when the image is formed in a state in which said inner roller is in the second position, the speed ratio Vp/Vb is a second speed ratio smaller than the first speed ratio.

2. An image forming apparatus according to claim 1, wherein when said inner roller is in the first position, said controller controls said driving source so that the driving speed Vp of said feeding member is higher than the driving speed Vb of said intermediary transfer belt.

3. An image forming apparatus according to claim 2, wherein when said inner roller is in the second position, said controller controls said driving source so that the driving speed Vp of said feeding member is lower than the driving speed Vb of said intermediary transfer belt.

4. An image forming apparatus according to claim 1, wherein in a case that said inner roller is in the second position, said controller controls said driving source so that the speed ratio Vp/Vb is a third speed ratio when a thickness of the recording material is a first thickness and so that the speed ratio Vp/Vb is a fourth speed ratio smaller than the third speed ratio when the thickness of the recording material is a second thickness thicker than the first thickness.

5. An image forming apparatus according to claim 4, when said inner roller is in the first position, said controller controls said driving portion so that the driving speed Vp of said feeding member is constant irrespective of the thickness of the recording material.

6. An image forming apparatus according to claim 1, wherein said outer roller is rotated by rotation of said intermediary transfer belt.

7. An image forming apparatus according to claim 1, wherein the first offset amount is zero or a negative value.

8. An image forming apparatus according to claim 1, further comprising a guiding member provided upstream of the transfer nip with respect to a feeding direction of the recording material and configured to guide the recording material to the transfer nip.

9. An image forming apparatus according to claim 1, wherein said stretching rollers includes a driving roller configured to drive said intermediary transfer belt.

10. An image forming apparatus comprising:
an image forming portion configured to form a toner image;
a rotatable intermediary transfer belt onto which the toner image formed by said image forming portion is transferred;
a plurality of stretching rollers stretching said intermediary transfer belt and including an inner roller and an upstream roller provided adjacent to said inner roller on a side upstream of said inner roller with respect to a rotational direction of said intermediary transfer belt;
an outer roller contacting an outer peripheral surface of said intermediary transfer belt and configured to form a transfer nip, where the toner image is transferred from said intermediary transfer belt onto a recording material, by nipping said intermediary transfer belt between itself and said inner roller;
a driving source configured to drive said outer roller;
a moving mechanism capable of moving a position of said inner roller between a first position where an offset amount X is a first offset amount X1 and a second position where the offset amount X is a second offset amount X2 which is larger than the first offset amount X1 and which is larger than zero, wherein in a cross section perpendicular to a rotational axis direction of said inner roller, an external common tangential line between said inner roller and said upstream roller on a side where said intermediary transfer belt is stretched by these rollers is a reference line L1, a rectilinear line passing through a rotation center of said inner roller and perpendicular to the reference line L1 is an inner roller center line L2, a rectilinear line passing through a rotation center of said outer roller and perpendicular to the reference line L1 is an outer roller center line L3, and a distance between the inner roller center line L2 and the outer roller center line L3 is the offset amount X which is a positive value when the outer roller center line L3 is positioned upstream of the inner roller central line L2 with respect to the rotational direction of said intermediary transfer belt; and
a controller configured to control said driving source,
wherein said controller controls said driving source so that
when an image is formed in a state in which said inner roller is in the first position, a speed ratio Vp/Vb wherein Vp is a driving speed of said outer roller and Vb is a driving speed of said intermediary transfer belt is a first speed ratio, and
when the image is formed in a state in which said inner roller is in the second position, the speed ratio Vp/Vb is a second speed ratio smaller than the first speed ratio.

11. An image forming apparatus according to claim 10, wherein when said inner roller is in the first position, said controller controls said driving source so that the driving speed Vp of said outer roller is higher than the driving speed Vb of said intermediary transfer belt.

12. An image forming apparatus according to claim 11, wherein when said inner roller is in the second position, said controller controls said driving source so that the driving speed Vp of said outer roller is lower than the driving speed Vb of said intermediary transfer belt.

13. An image forming apparatus according to claim 10, wherein in a case that said inner roller is in the second position, said controller controls said driving source so that the speed ratio Vp/Vb is a third speed ratio when a thickness of the recording material is a first thickness and so that the speed ratio Vp/Vb is a fourth speed ratio smaller than the third speed ratio when the thickness of the recording material is a second thickness thicker than the first thickness.

14. An image forming apparatus according to claim 13, when said inner roller is in the first position, said controller controls said driving portion so that the driving speed Vp of said outer roller is constant irrespective of the thickness of the recording material.

15. An image forming apparatus according to claim 10, further comprising a guiding member provided upstream of the transfer nip with respect to a feeding direction of the recording material and configured to guide the recording material to the transfer nip.

16. An image forming apparatus according to claim 10, further comprising:
a feeding member configured to feed the recording material to the transfer nip; and
a second driving source configured to drive said feeding member;
wherein said controller controls said second driving source so that
when an image is formed in a state in which said inner roller is in the first position, a speed ratio Vr/Vb wherein Vr is a driving speed of said feeding member and Vb is a driving speed of said intermediary transfer belt is a third speed ratio, and
when the image is formed in a state in which said inner roller is in the second position, the speed ratio Vr/Vb is a fourth speed ratio smaller than the third speed ratio.

17. An image forming apparatus according to claim 10, wherein said stretching rollers includes a driving roller configured to drive said intermediary transfer belt.

18. An image forming apparatus according to claim 10, wherein the first offset amount is zero or a negative value.
